(19) United States
(12) Patent Application Publication
(10) Pub. No.: US 2009/0046856 A1
(43) Pub. Date: Feb. 19, 2009

(54) METHODS AND APPARATUS FOR ENCRYPTING, OBFUSCATING AND RECONSTRUCTING DATASETS OR OBJECTS

(76) Inventor: Alan James Mitchell, Bedfordshire (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/090,912

(22) PCT Filed: Oct. 5, 2006
(86) PCT No.: PCT/GB2006/003699

§ 371 Date: Jun. 26, 2008

(30) Foreign Application Priority Data
Oct. 20, 2005 (GB) 0521333.5
Jul. 18, 2006 (GB) 0614175.8

(51) Int. Cl. H04L 9/06

(52) U.S. Cl. 380/243

(57) ABSTRACT

A method of encrypting or obfuscating a first dataset, the dataset comprising a plurality of data elements, the method comprising distributing the data elements among one and at least one other of a plurality of discrete further datasets. Also provided is a method of reconstructing a first dataset from two or more further datasets, comprising mapping the said two or more further datasets onto one another. Inter alia, the disclosure further provides apparatus and documents comprising a plurality of layers, wherein the layers may be rotated, separated or otherwise manipulated to encrypt, obfuscate or reconstruct an object, pattern or image formed by the layers.

This invention relates to methods, apparatus and associated systems for encrypting, obfuscating and reconstructing datasets or objects. It is particularly applicable, but by no means limited, to providing security for electronic data.

### BACKGROUND TO THE INVENTION

Since the information revolution, the control of data has become integral to every aspect of society—from ensuring world economies continue to operate, assisting countries in the storage of their historical data, to just managing the identity of a single human being. Without the evolution of security measures and means to control systems access and data transmission, the foundations and building blocks of the information age would have been severely damaged and the human race would have been hindered in its development into the 21st Century. However this battle is ongoing; continuously we see new methods of security and encryption have been developed, only to find they have inherent weaknesses or have been broken, or are not feasible for the entire community due to the technical understanding required to implement them.

The original information which is to be protected by cryptography is called the “plaintext”. “Encryption” is the process of converting plaintext into an unreadable form, termed “ciphertext”, or, occasionally, a “cryptogram”. “Decryption” is the reverse process, recovering the plaintext back from the ciphertext. Enciphering and deciphering are alternative terms for encryption and decryption. A “cipher” is an algorithm for encryption and decryption. The exact operation of ciphers is normally controlled by a key—some secret piece of information that customises how the ciphertext is produced. “Protocols” specify the details of how ciphers (and other cryptographic primitives) are to be used to achieve specific tasks. A suite of protocols, ciphers, key management, and user-prescribed actions implemented together as a system constitute a “cryptosystem”; this is what an end-user interacts with, e.g. PGP or GPG. Generally, all practical cryptographic systems are now computer programs.

While encryption has been used to protect communications for centuries, only organisations and individuals with an extraordinary need for secrecy have made use of it. In the mid-1970s, strong encryption emerged from the sole preserve of secretive government agencies into the public domain, and is now employed in protecting widely-used systems, such as Internet e-commerce, mobile telephone networks and bank automatic teller machines.

Modern cryptography, on the other hand, is implemented in software or hardware and is used for a diverse range of applications; for many cases, a chosen-plaintext attack is often very feasible. In addition, any cipher that can prevent chosen-plaintext attacks is then also guaranteed to be secure against known-plaintext and ciphertext-only attacks; this is a conservative approach to security.

Encryption techniques may be applied to many different items of data. For example, when a software company supplies a user with a password (e.g. to enable him to register a new software application or to gain access to a secure internet site), this password should be transmitted extremely securely. If intercepted, the password should not be in a form that a hacker or unauthorised user can understand or use fraudulently. Additionally, when the password is finally displayed on the user's computer screen, it is desirable that it should be displayed in a manner such that bystanders cannot readily read the password.

Disk encryption is a computer security technique that encrypts data stored on a computer's mass storage and automatically decrypts the information when an authorized user requests it. Disk encryption systems intercept operating system read and write operations and carry out the appropriate cryptographic transformations without any special action by the user except supplying a password or pass phrase at the beginning of a session. Disk encryption can apply to a directory or an entire disk volume.

In other circumstances, a user may wish to encrypt an entire data file, such as a word processor file, an image file, a spreadsheet file, a database file, or any other kind of data file. This may be in order to transmit it securely (e.g. over a network), or simply to store it in a secure manner on a server or other storage device.

In cryptography, encryption is the process of obscuring or obfuscating information to make it unreadable without special knowledge or intelligence. However, weaknesses exist through insecure creation and handling of plaintext, allowing an attacker to bypass current cryptography altogether. Plaintext is very vulnerable in use and in storage, whether it is in electronic or physical (e.g. paper) format. It is the very existence of the original dataset in a plain-text form and the conversion process of a cipher-text dataset back to plain-text that is inherently insecure about current encryption techniques. A cryptographic system, implementable at the point of creation of any dataset, that addresses the existence and availability of the original dataset and which impedes the ability of a human or non-human entity to reconstruct the dataset, would be advantageous and vastly improve upon current cryptographic techniques.

A further desire exists to protect the identity of individuals against so-called “identity theft”. This may happen when a recipient of a printed document (the document bearing the recipient's name, address, bank account details, or other personal details) discards that document and it is subsequently found and misused by a wrongdoer passing himself off as the true recipient. For example, the document may be a bank statement or a utility bill, and the wrongdoer may use that document to open a fraudulent bank account in the name of the true recipient, which may then be used in connection with criminal activities. Alternatively, the wrongdoer may fraudulently take out a loan in the name of the true recipient or may run up significant debts, or may fraudulently obtain a credit card and then use it to make illegal purchases. Other examples of identity theft, and illegal activities performed by identity thieves, will be known to those skilled in the art of data protection and security.

### SUMMARY OF THE INVENTION

According to a first aspect of the invention there is provided a method of encrypting or obfuscating a first dataset, the dataset comprising a plurality of data elements, the method comprising distributing the data elements among one and at least one other of a plurality of discrete further datasets.

The term “dataset” should be interpreted broadly, to encompass, for example, an image, alphanumeric characters and/or graphemes, a binary, hexadecimal or other datastream, audio and/or video data, or a data file (e.g. a word processor file, a database file, an application or program file, or some other kind of data file). It will be appreciated by those skilled in the art that other types of datasets are possible, and the present disclosure is intended to apply to all existing types of datasets and those that have yet to be devised.

The terms “further dataset” and “further datasets” as used herein may also be referred to herein as “layer” or “layers” respectively.

By distributing the data elements of the first dataset among the plurality of discrete further datasets, the security of the first dataset is enhanced since any interceptor or hacker who merely intercepts one (or conceivably some but not all) of the further datasets would not be able to reconstruct the first dataset, and would therefore not be able to avail himself of the information contained therein.

Preferably the method further comprises dividing the first dataset into a plurality of cells, and the step of distributing the data elements comprises distributing the said cells among one and at least one other of the plurality of discrete further datasets.

The term “cell” as used herein should be interpreted broadly, to encompass any structure or framework by which the data elements in a dataset may be divided. For example, a cell may comprise a single data element, a plurality of data elements, or some fraction of one or more data elements.

The absolute spatial or temporal position of a specific cell distributed into a further dataset may be the same as the absolute spatial or temporal position of the said cell in the first dataset. Alternatively, the relative spatial or temporal positions of specific cells distributed into a further dataset may be the same as the relative spatial or temporal positions of the said cells in the first dataset. Other relationships between the positions of the cells in the first dataset and the cells when distributed into a further dataset are possible.

The position of the distributed cells in the further datasets may be such that the first dataset may be reconstructed by mapping the further datasets onto one another. The mapping of the further datasets required in order to reconstruct the first dataset may be direct (i.e. one-on-one mapping). Alternatively, the position of the distributed cells in the further datasets may be such that the first dataset may be reconstructed by displacing one of the further datasets relative to another and then mapping the datasets onto one another. Further alternative mapping operations are possible—for example, enlarging or reducing one of the further datasets relative to the other, or translating, rearranging or inverting one or more of the further datasets and then mapping the datasets onto one another. Moreover, a combination of mapping operations such as these may be required to reconstruct the first dataset.

The potential complexity of the mapping operations required in order to reconstruct the first dataset provides the advantage that, even if the plurality of further datasets were all intercepted, it would be difficult (if not impossible) for the hacker to recombine them in such a manner as to reconstruct the first dataset.

The first dataset may be one of a plurality of first datasets, and the method may comprise distributing data elements from each of the plurality of first datasets among one and at least one other of the plurality of discrete further datasets. Preferably the step of distributing the data elements results in at least one of the further datasets comprising data elements from a plurality of first datasets. In this manner, a plurality of first datasets may be intermingled or otherwise combined with one another in order to form the further datasets, thereby making it harder for a would-be hacker to reconstruct the first datasets.

The step of distributing the data elements may be performed using vector migration of the data elements. As a consequence, complex mapping operations may be required in order to reconstruct the first dataset(s), thereby further improving security.

Additional obfuscation techniques may be employed, such as adding additional data elements (which may be chosen at random) between the distributed data elements in the further datasets.

Preferably the method further comprises transmitting the further datasets on separate data communications channels or networks. This further decreases the likelihood of a hacker being able to intercept the constituent “layers” needed to reconstruct the first dataset.

In another embodiment, the method further comprises printing the further datasets on printable media, the printable media being separable from one another in order to obfuscate the first dataset. Such an embodiment may advantageously be used, for example, to combat identity theft from items of discarded post, as described later herein.

The further datasets may be printed on separable layers of printable media, such that separation of the layers of printable media obfuscates the first dataset.

Alternatively, one or more of the separable layers of printable media may incorporate holes, apertures or transparent regions, such that a further dataset printed on a lower layer may be viewed in combination with a further dataset printed on an upper layer in order to show the complete first dataset prior to obfuscation.

In one particularly preferred embodiment, a further dataset may be printed on a document and another further dataset may be printed on a transparent region of an envelope.

In other embodiments, the further datasets may be printed such that the separable layers of printable media must be rotated, aligned and/or reversed relative to one another in order to show the complete first dataset.

In yet further embodiments, the further datasets may be printed in separate separable regions of a printable media. The separate separable regions may comprise peel-off labels or the like.

According to a second aspect of the invention there is provided a method of reconstructing a first dataset from two or more further datasets, comprising mapping the said two or more further datasets onto one another.

To reconstruct the first dataset, it may be necessary for the said two or more further datasets to be directly mapped onto one another. Alternatively, one of the further datasets may be displaced relative to another and then the datasets mapped onto one another. Alternatively, the reconstruction method may comprise enlarging or reducing one of the further datasets relative to the other and then mapping the datasets onto one another. A combination of mapping operations such as these may be required to reconstruct the first dataset.

The method may comprise varying the mapping with time such that the relative positions of the further datasets change with time, such that the first dataset is only reconstructed for an instant in time. This provides the advantage that, if the first dataset is a password, for example, then it may be correctly reconstructed on a computer screen for only a brief instant in time. Prior to, and after, the correct reconstruction of the password, the mapping changes and the constituent datasets move relative to one another on the screen. Accordingly, a bystander who happens to look at the computer screen would be unlikely to glean the reconstructed password. Thus, in this manner, time is used as an extra dimension of the encryption or obfuscation procedure, further enhancing security.

Alternatively, the method may comprise alternating the mapping or presentation of the further datasets with time. This may be used to show the user one of the further datasets and then the other in a temporally alternating fashion.

The method may comprise performing one or more vector migrations of the data elements within the further datasets.

The method may further comprise removing data elements in order to reconstruct the first dataset(s).

Additionally, the method may further comprise providing a user with a key or instructions in order to enable him to reconstruct the first dataset.

According to a third aspect of the invention there is provided a method of encrypting a first audio dataset, the audio dataset comprising a plurality of audio data elements, the method comprising distributing the audio data elements among one and at least one other of a plurality of discrete further audio datasets according to the frequency of the audio data elements.

According to a fourth aspect of the invention there is provided a method of encrypting a first audio or video dataset, the audio or video dataset comprising a plurality of audio or video data elements, the method comprising distributing the data elements among one and at least one other of a plurality of discrete further audio or video datasets according to the temporal position of the data elements within the first audio or video dataset.

Such techniques for the division of an audio dataset (e.g. a music data file) advantageously mean that the user is required to recombine the further audio datasets (or audio “layers”) in order to play the initial audio dataset. This has important practical applications in the transmittal and playback of audio files such as pop music downloaded from the internet or otherwise distributed electronically. For example, playback software may be configured to only permit the audio layers to be recombined a certain number of times for playback (e.g. if the music was downloaded on a trial basis, with the user being required to pay if he wishes to listen to the music on further occasions).

The user may be required to play the further audio datasets simultaneously (e.g. using dedicated software) in order to recreate the original sound. Since the audio layers would only be played simultaneously, and never actually combined to form the initial audio dataset prior to audio playback, this advantageously means that unauthorised copies of the initial audio dataset can be prevented from being made.

Accordingly, a fifth aspect of the invention provides a method of reconstructing a first audio or video dataset from two or more further audio or video datasets, comprising mapping the said two or more further audio or video datasets onto one another.

According to a sixth aspect of the invention there is provided a computer program for executing a method of encrypting, obfuscating or reconstructing a dataset in accordance with the first, second, third, fourth or fifth aspects of the invention.

According to a seventh aspect of the invention there is provided a computer program in accordance with the sixth aspect of the invention, stored on a data carrier.

Further, according to an eighth aspect of the invention there is provided a processor programmed to execute a method of encrypting, obfuscating or reconstructing a dataset in accordance with the first, second, third, fourth or fifth aspects of the invention.

According to an ninth aspect of the invention there is provided apparatus comprising a plurality of layers, wherein the layers may be rotated or otherwise manipulated to encrypt, obfuscate or reconstruct an object, pattern or image formed by the layers. Such apparatus has applications as a toy or a sculpture, or for security/authorisation purposes.

In a first embodiment of the ninth aspect of the invention, the layers may be mechanically rotatable and operable to encrypt, obfuscate or reconstruct the object, pattern or image at specific time intervals. Such apparatus may be used as an executive toy, or as a large scale sculpture for use in marketing, branding or advertising.

In a second embodiment of the ninth aspect of the invention, the layers may comprise transparent, semi-transparent and/or opaque regions, and the layers may be mechanically or manually rotatable in order to encrypt, obfuscate or reconstruct a pattern or image formed by the layers.

Preferably the apparatus further comprises a scanning device arranged to detect when the pattern or image has been correctly reconstructed. An output signal indicative of the pattern or image having been correctly reconstructed may be provided by the scanning device, which in turn may be used to confirm the user's identity or to verify his access clearance.

The apparatus may further comprise a light source, and the layers may be arranged between the light source and the scanning device. Accordingly, the apparatus may be configured such that the user is required to manipulate the layers until they are in a precise position, in which only certain amounts and specific patterns of light reach the scanning device, in order for access to be authorised.

Thus, a tenth aspect of the invention provides a method of verifying a user's identity or authorisation status for security purposes, comprising providing the user with apparatus in accordance with the ninth aspect of the invention and requiring the user to correctly reconstruct the object, pattern or image.

According to an eleventh aspect of the invention there is provided a document and an envelope, wherein the envelope incorporates a transparent region, and wherein data such as the name and/or address of the recipient is partly printed on the document and partly printed on the said transparent region, the printing being arranged such that, when the document is inserted into the envelope, the data printed on the document is in alignment with the data printed on the said transparent region such that the data may be legibly viewed as a whole, and when the document is removed from the envelope the data is fragmented and thus obfuscated.

The term “document” as used herein should be interpreted broadly, to encompass any written or printed physical item, such as a letter, a bank account or credit card statement, a utility bill, a pay slip, etc. The term “envelope” should also be interpreted broadly, to encompass not only conventional envelopes, but also any other form of sleeve or outer covering in which the document may be delivered or posted.

According to a twelfth aspect of the invention there is provided a method of printing data, comprising printing data such as the name and/or address of a recipient partly on a document and partly on a transparent region incorporated in an envelope, the printing being arranged such that, when the document is inserted into the envelope, the data printed on the document is in alignment with the data printed on the said transparent region such that the data may be legibly viewed as a whole, and when the document is removed from the envelope the data is fragmented and thus obfuscated.

This method, and the document and envelope mentioned above, may advantageously be employed to combat identity theft. By causing the recipient's data to be fragmented and obfuscated on removal of the document from the envelope, a wrongdoer who finds the document will not be able to read or misuse the data for fraudulent or criminal purposes. Other applications, in which it is desired to prevent subsequent reading of the said data, will be apparent to those skilled in the art.

According to a thirteenth aspect of the invention there is provided a document comprising a plurality of layers of printable media, wherein data is printed in a distributed manner on the layers, the data being wholly viewable when the layers are overlaid, and the layers being separable in order to enable the data to be obfuscated.

The layers may comprise holes, apertures or transparent regions to enable data printed on one or more underneath layers to be viewed in combination with data printed on one or more upper layers.

Thus, according to a fourteenth aspect of the invention there is provided a method of printing, comprising printing data on a document having a plurality of separable layers of printable media, the data being printed in a distributed manner on the layers such that the data is wholly viewable when the layers are overlaid, and such that the data may be obfuscated when the layers are separated.

Such documents and methods may advantageously be used to combat identity theft, or to enable the printed data to be rendered illegible after having been read. This may be used for classified information or “eyes only” documents which must only be read once and then destroyed. Other applications will be apparent to those skilled in the art.

According to a fifteenth aspect of the invention there is provided a document comprising one or more removable regions removably attached to a substrate, and having print on and adjacent to the removable region(s), or having print on adjacent removable regions, the print being arranged such that removal of one or more removable region(s) causes fragmentation and thus obfuscation of the print.

The removable regions may be attached to the substrate by adhesive, such that they may be peeled off in order to obfuscate the print.

Accordingly, a sixteenth aspect of the invention provides a method of printing, comprising printing on a document comprising one or more removable regions removably attached to a substrate, the print being printed on and adjacent to the removable regions, or on adjacent removable regions, and arranged such that removal of one or more removable region(s) causes fragmentation and thus obfuscation of the print.

Such documents and methods may also advantageously be used to combat identity theft, or to enable the printed data to be rendered illegible after having been read. As mentioned above, such documents and methods may be used for the presentation of classified information or “eyes only” documents which must only be read once and then destroyed. Other applications will be apparent to those skilled in the art.

### BRIEF DESCRIPTION OF THE DRAWINGS

Embodiments of the invention will now be described, by way of example, and with reference to the drawings in which:

FIG. 1 illustrates schematically the division and layering methodology in accordance with embodiments of the present invention;

FIG. 2 illustrates a first embodiment of a method for image encryption (SLISE_Ia);

FIG. 3 illustrates a second embodiment of a method for image encryption (SLISE_Ib);

FIG. 4 illustrates a third embodiment of a method for image encryption (SLISE_Ic);

FIG. 5 illustrates a fourth embodiment of a method for image encryption (SLISE_Id);

FIG. 6 illustrates a fifth embodiment of a method for image encryption (SLISE_Ie);

FIG. 7 illustrates a sixth embodiment of a method for image encryption (SLISE_If);

FIG. 8 illustrates a seventh embodiment of a method for image encryption (SLISE_Ig);

FIG. 9 illustrates an eighth embodiment of a method for image encryption (SLISE_Ih);

FIG. 10 shows a procedural flow diagram relating to a ninth embodiment of a method for image encryption (SLISE_Ii);

FIG. 11 shows a procedural flow diagram relating to a tenth embodiment of a method for image encryption (SLISE_Ij);

FIG. 12 illustrates an eleventh embodiment of a method for image encryption (SLISE_Ik);

FIG. 13 illustrates a twelfth embodiment of a method for image encryption (SLISE_Ik);

FIG. 14 illustrates a thirteenth embodiment of a method for image encryption (SLISE_Im);

FIG. 15 illustrates a fourteenth embodiment of a method for image encryption (SLISE_In);

FIGS. 16, 17 and 18 illustrate a fifteenth embodiment of a method for image encryption (SLISE_Io);

FIGS. 19 and 20 illustrate a first embodiment of a method for grapheme or numeral encryption (SLISE_GNa);

FIG. 21 illustrates a second embodiment of a method for grapheme or numeral encryption (SLISE_GNb);

FIG. 22 illustrates a third embodiment of a method for grapheme or numeral encryption (SLISE_GNc);

FIGS. 23 and 24 illustrate a fourth embodiment of a method for grapheme or numeral encryption (SLISE_GNd);

FIGS. 25, 26 and 27 illustrate a fifth embodiment of a method for grapheme or numeral encryption (SLISE_GNe);

FIG. 28 illustrates a high level flow diagram of a receiver system retrieving datasets encrypted using a SLISE_GN security technique, and thereby receiving the plaintext dataset;

FIG. 29 illustrates a first embodiment of a method for radio frequency, video or sound encryption (SLISE_RFVSa);

FIG. 30 illustrates a variant of the first embodiment of a method for radio frequency, video or sound encryption;

FIG. 31 illustrates a second embodiment of a method for radio frequency, video or sound encryption (SLISE_RFVSb);

FIG. 32 illustrates an embodiment of a method for video encryption (SLISE_Va);

FIG. 33 illustrates a first embodiment of a physical application of the SLISE technique (SLISE_Pa);

FIG. 34 illustrates a second embodiment of a physical application of the SLISE technique (SLISE_Pb);

FIG. 35 is a procedural flow diagram depicting a first high level algorithm for data encryption;

FIG. 36 is a procedural flow diagram depicting a second high level algorithm for data encryption;

FIG. 37 is a procedural flow diagram depicting a high level algorithm for data decryption;

FIG. 38 is a procedural flow diagram depicting a prior art algorithm for data encryption and decryption;

FIG. 39 is a procedural flow diagram providing an overview of SLISE techniques for data encryption and decryption;

FIG. 40 illustrates a fifteenth embodiment of a method for image encryption (SLISE_Io);

FIG. 41 is a procedural flow diagram to illustrate a third embodiment of a physical application of the SLISE technique (SLISE_Pc); and

FIGS. 42a and 42b illustrate an application of the SLISE_Pc technique, showing a dataset whole (FIG. 42a) and obfuscated (FIG. 42b).

### DETAILED DESCRIPTION OF PREFERRED EMBODIMENTS

The present embodiments represent the best ways known to the applicant of putting the invention into practice. However they are not the only ways in which this can be achieved.

A number of data encryption or obfuscation techniques have been developed, which are referred to herein by the acronym “S.L.I.S.E” (short for Specifically Layered Information Securely Encrypted). It should be emphasised that the present techniques are not limited to electronic operation, and that they can also be applied to non-electronic encryption or obfuscation.

Some of the present embodiments involve processing steps that may form part of a computer program or a set of instruction code, that may be executed on a computer or other processing device. Such a computer program or set of instruction code may be supplied on a data carrier such as a CD-ROM or floppy diskette, or may be downloadable as a digital signal over a network such as the Internet. Alternatively a processor arranged to execute the processing steps may be hard coded to implement such a program.

### 1. Introduction to S.L.I.S.E

Design and implementation of an influential modern cryptosystem is the drive behind S.L.I.S.E. The S.L.I.S.E system relates to the encryption of systems and data, including secure transmission of information (from a networking viewpoint it can be introduced at nearly every level of the OSI 7 Layer Model). The S.L.I.S.E system addresses a number of problems we currently face with data transmission, systems access, data retrieval, system attacks and control of data in a physical form, thus:
Database and data storage systems contain large amounts of data that, if unauthorised or malicious access is gained, can be retrieved, understood, and in many cases used in criminal or detrimental activity (e.g. a recent bank scam performed using financial details obtained from a call centre in India). This removes the ability of the system to remain secure and perform its role. The data would then need to be changed or re-secured. In most cases it will be impossible for the complete dataset to be changed or re-secured. In addition, the time, cost and the loss of reputation involved in changing or re-securing specific parts of the dataset would then be substantial.
Secure data access currently has several issues surrounding effective retrieval due to restricted access or systems availability. An encryption technique that is a true one-way automated process, with restricted or public “key” access, could improve security whilst allowing for improved data retrieval and access capabilities.
Whilst secure data is being viewed it is possible for it to be captured (e.g. a person seeing it, taking a photo of it, or a program recording it). This destroys the data's ability to remain secure but also be displayed when required.
When accessing a public system containing private data, it is possible for multiple unauthorised access attempts to take place quickly and easily by multiple attackers. If users are not assured that measures are in place to stop unauthorised access to their profile, personal or account data, then trust dissolves and demand for or benefit from the system disappears.
The process of storing, requesting and checking the input of a string of data that is only known by the owner or specified persons can fail due to users forgetting the password or passphrase and then being unable to remember it based on a question and/or answer hint procedure. The reset and confirmation process for exceptions is less secure and reduction of this step is required to improve systems access security.
Transmitting data across any type of infrastructure to another person makes it possible for this data to be obtained, listened into or recorded by persons other than the intended recipient.
Transmission, delivery and disposal of data once printed into a physical form (i.e. on paper or other material) is currently an unprotected step in the management of data, due to the full data being available to all to read, and susceptible to unauthorised retrieval of this data from the physical object when in an unprotected position (e.g. once disposed of in household or office waste).

### 2. S.L.I.S.E Overview

In a simple form S.L.I.S.E can be considered as the conversion of a dataset into multiple cells of data which are then distributed cell by cell into multiple new datasets or data “layers”. It may be considered as taking a dataset stored in any format (Image, Graphemes, Numerals or Sound), migrating the data into a 3D (or further dimensional) model, and mathematically migrating cells of data into separate layers. Because the cells are distributed (or “divided”) into individual layers (e.g. SLISE1=Cells A1,C1,B2 & SLISE2=Cells B1,A2,C2) the system can ensure that only a layer of the original data is contained in each new dataset. A user or operator would then be required to recombine, overlay or display the SLISE created layers to allow the information contained to be retrieved. Only an owner or creator of the dataset would quickly and easily be able to confirm or recall the contents of the dataset with only one of the SLISE layers (dependent on the amount of data the original dataset contained and the level of knowledge/intelligence possessed).

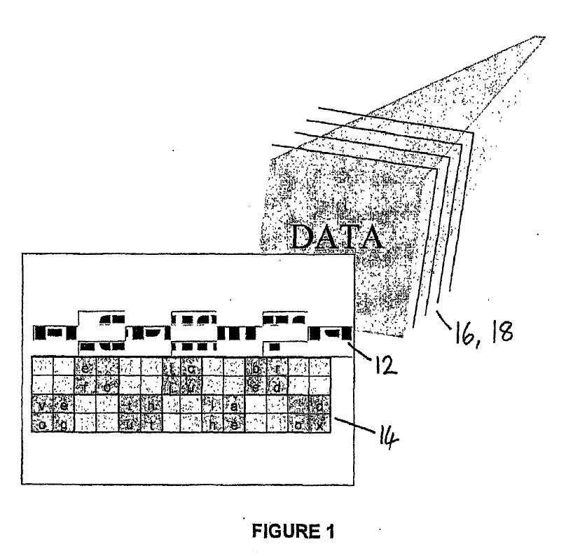

FIG. 1 illustrates a basic example of the division and layering methodology of SLISE, applied to image-based and text-based division. In preparing this figure, examples of graphics and textual phrases have been divided into a plurality of cells, with only some cells having being distributed to the specific layers (12, 14) shown. It will be appreciated that any hacker or casual observer who intercepts or views these isolated layers 12, 14 will be unable to understand the full content or meaning of the graphics or text. However, as will be described in detail below, subsequent overlay or reconstruction of these two SLISE layers 12, 14 with their corresponding SLISE layers 16, 18 (not fully shown in FIG. 1) would enable the original datasets to be reformed, displayed or understood.

### 3. S.L.I.S.E—Basics

### Overall Implementation Basics

1. Dataset and layers can be any size and shape (2D, 3D or 4D).
2. Dataset and layers can be converted to any size and shape (2D, 3D or 4D), independent of original data features.
3. A cipher key is an optional requirement based on version.
4. Data is divided into cells based on the original data size. These are then separated and distributed into multiple layers of data which may subsequently be overlaid or merged to restore the original data.
5. Data division can be implemented regardless of data size; the layering of data could be implemented on textual elements, documents, a single storage device, multiple storage devices or across a data centre or storage area campus. These could also be implemented in conjunction with each other to increase the hardness of encryption—e.g. divide and layer text strings, then divide and layer strings in documents, then divide and layer datasets in storage devices, then divide and layer the storage device datasets in the estate/campus. This hierarchical division and layering technique hardens at each layer it is subjected to.
6. Implementation of a continuous reshuffling technique on data layers between storage locations or positions in the dataset would further improve the hardness of the encryption and ensure time limits are in place restricting the length of time valid attempts can be made to “match” layers, thus reducing the probability of plaintext data being retrieved/deciphered.

### Image Implementation

1. Images can contain any form or combination of data: e.g. colours, pictures, patterns, alphanumeric characters, graphemes or numerals.
2. Grapheme or numeral size contained within the image is non-dependent on the actual size of the image. The required level of division and layering will be configured accordingly.
3. Data division can take place at any level i.e. ¼,½ or whole fraction ( 1/1) of graphemes or numerals. For an example of whole ( 1/1) division see SLISE_In version.

### Grapheme/Numeral Implementation

Human or computer based language systems at a grapheme/numeral level (e.g. English language, binary bits, hexadecimal code, decimal data, or other computing programming languages) can be divided using the SLISE cryptosystem. Cell grouping size can be set at any level and shape, 1×1 grapheme/numeral upwards. Overall implementation basics 1-6 above also apply to the Grapheme/Numeral implementation. An overlay technique allows the original data to be restored.

### Sound and Video Implementation

A sound recording or transmission can be divided using the SLISE cryptosystem. Overall implementation basics 1-6 above also apply to the Sound implementation. Thus, audio data can be divided into separate audio datasets or “layers”. An overlay technique allows the original sound to be restored from the layers. Playback may be achieved by first combining the audio layers to reconstruct the initial audio data and then playing the audio, or by simultaneously playing the audio layers. Video and other multimedia recordings can also be divided using the SLISE cryptosystem and subsequently recombined or played simultaneously to enable the original data to be restored.

### Radio Frequency Implementation

A sound, video or other RF transmission can be divided using the SLISE cryptosystem, regardless of wavelength. For a video or movie, for example, it would be possible to produce SLISE layers of both audio and video datasets. Overall implementation basics 1-6 above also apply to the Radio Frequency implementation. A simultaneously play or display technique allows the original data to be restored.

### Video Frame and Frame Rate Implementation

Overall basics 1-6 above apply. Simultaneously play allows data to be restored.

### Physical Implementation:

Overall basics 1-6 above apply. Visual perspective of layers allows data to be restored.

### 4. S.L.I.S.E—Versions and Features

### 4.1 Image Versions

### a) SLISE_Ia (Base Image Version)

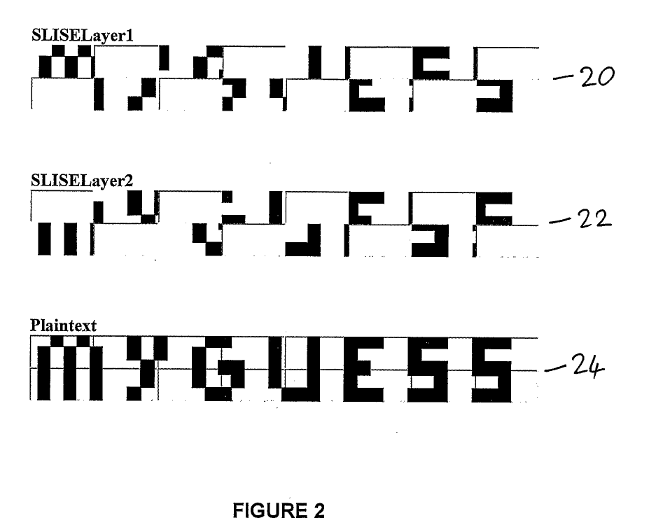

As illustrated in FIG. 2, this “SLISE_Ia” embodiment provides multiple image layer division of data.

This example uses an 8 column and 2 row configuration to divide the original image dataset 24 (an image of the phrase “MY GUESS”) into 16 cells. The cells in each row are then distributed in an alternating manner into two SLISE images 20, 22, each containing 8 cells of separated data, thus obfuscating the original image data.

The cell data is distributed in an alternating manner between SLISELayer1 (20) and SLISELayer2 (22), using alternating cells in each row or column. When starting each new row or column, the first cell allocation is alternated from the previous row or column. Thus multiple SLISE layers of data (ciphertext) are created, as shown in FIG. 2. Depending on the size of the image and the data placement, an optimal obfuscation table may be referred to, to determine the optimum number of rows and columns (See also: SLISE Algorithms).

In this example the image layers 20 and 22 may be overlaid exactly on top of one another (i.e. using a 1:1 mapping) to re-display or reconstruct the original data (plaintext) 24 and to enable the original data to be understood. Thus, in this example, overlaying the layers 20 and 22 will result in the reconstruction of the image of the phrase “MY GUESS” 24.

Grapheme or numeral division within images can take place at varying fraction denominator levels, from whole (1) through the most common ½ and ¼ division of each grapheme or numeral. Any denominator could be applied as long as the layers are increased to allow the quotient to provide suitable obfuscation. Resultant data layers are assigned a fraction of the original data in an alternative (1,2,1,2) fashion

### b) SLISE_Ib

The “Ib” image overlay technique incorporates use of colour or negative (inverse colour) based definitions and advisory data (key). Multiple images and layers are displayed and the user is advised which coloured image layers need to be overlaid in order to display the required dataset (plaintext).

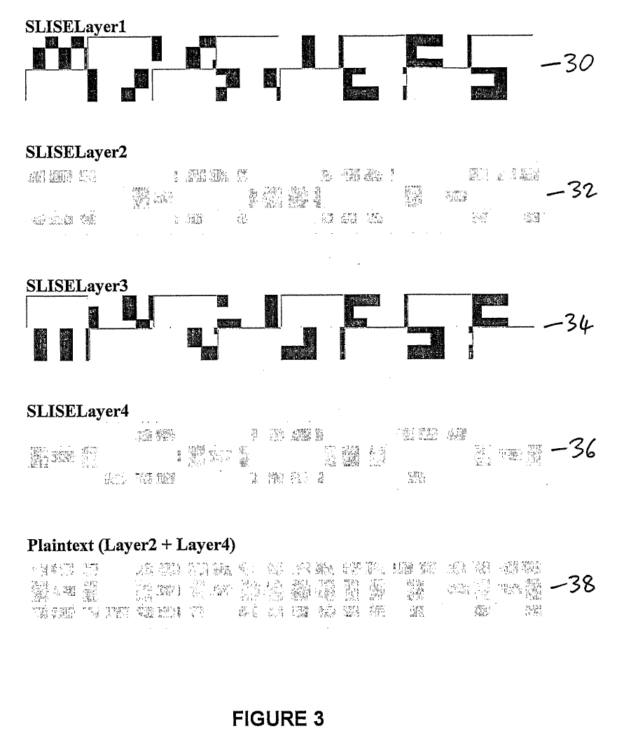

FIG. 3 shows an example of a SLISE_Ib sample using multiple layers of coloured SLISE images simultaneously. A user advisory (key) may be provided to confirm which colour layers must be overlaid, how many layers are required and how many strings must be retrieved.

In this example, a simple key advising the overlay of the dark coloured image layers 30 and 34 will enable the required dataset (the phrase “MY GUESS”) to be reconstructed. On the other hand, overlay of the light coloured image layers 32 and 36 would enable a second dataset 38 (the phrase “ELEPHANT99”) to be reconstructed. An advanced version would require the additional images to be re-formed for multiple strings to be retrieved or separate parts of a string to be found and concatenated. Also, overlaying various different colours (e.g. Blue+Red and/or Yellow+Green could be advised within the advisory key).

### c) SLISE_Ic

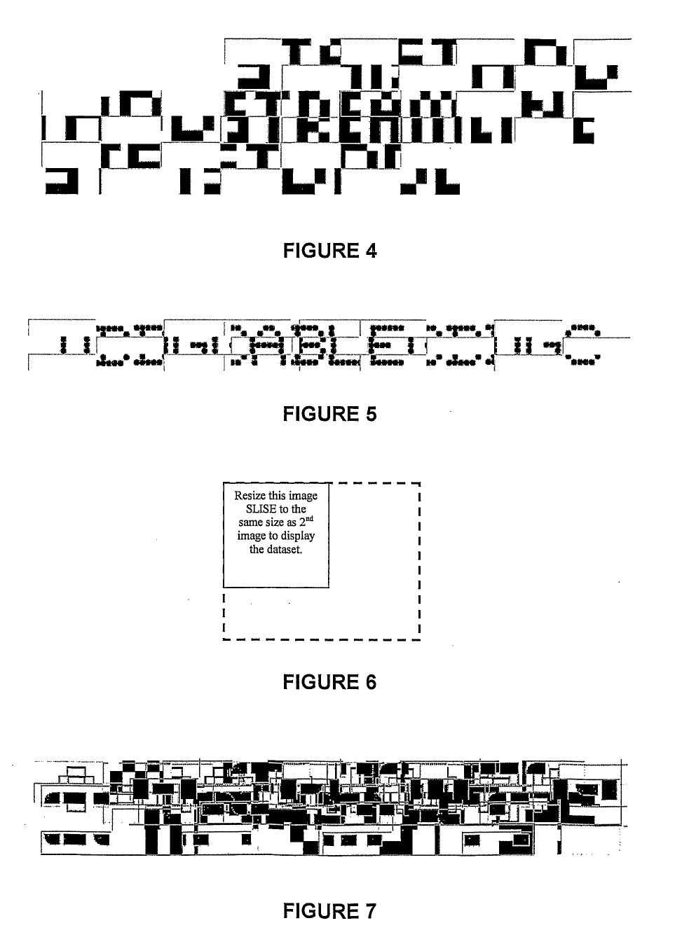

As shown in FIG. 4, the “Ic” image overlay technique incorporates SLISE image layers that are not overlaid exactly on top of each other in order to display the dataset (plaintext). Instead, to reconstruct the required dataset (in this example the word “STREAM”), the two layers are mutually displaced and then overlaid to reconstruct the dataset.

The first character of the data contained within each SLISE layer should commence from the same pixel within its primary cell, otherwise cell division will fail and the full image data will not be retrievable. This does not mean the data will no longer be legible but will hinder the user process based on the level of data visibility a user would expect to see to be able to confirm they have correctly overlaid the images to successfully display the dataset. No advisory key may be supplied in this SLISE version, although a key or advisory information may be provided if desired. This SLISE version removes the possibility of using image arithmetic to display the plaintext without manual intervention.

### d) SLISE_Id

With the “Id” image overlay technique, as shown in FIG. 5, SLISE image layers are displayed. SLISE table cell reference advisory data (key) is also provided to advise the user how to align the cell data of the layers in order to reconstruct the required dataset (plaintext) (which is the word “ABLE” in the example shown in FIG. 5).

### e) SLISE_Ie

As illustrated in FIG. 6, the “Ie” image overlay technique incorporates the action of resizable images, rotating images, invertible images or mirror image layers. An advisory (key) may be provided to inform the user which action is to be performed to display the dataset (plaintext). In further versions, the advisory key may additionally contain attribute data about the images that are valid or the actions that must be performed, for example advising the user to overlay the largest images, the images with the most characters, or the image with characters that are in a specific font. This therefore allows the user to be aware of what images and what actions must be taken in order to retrieve the plaintext datasets.

### f) SLISE_If

As illustrated in FIG. 7, the “If” image overlay technique incorporates the SLISE system loading multiple image datasets that have been divided into layers, but only requiring a single dataset to be reconstructed. The layers are either loaded on top of each other in a stack, or into specific white space areas, requiring the user to either move valid data layers (two or more) from the stack into clear space to display the dataset (plaintext) or via the image attributes visible to the user that can also be provided within an advisory key. As with all revisions of SLISE the layers can be additionally tagged to show which layers are relevant and need to be overlaid. The advisory key in further versions may additionally contain attribute data about the images that are valid or the actions that must be performed, for example advising the user to overlay the largest images, the images with the most characters, or the image with characters that are in a specific font. This therefore allows the user to be aware of what images and what actions must be taken in order to retrieve the plaintext datasets.

In the example shown in FIG. 7, the obfuscated image is formed from 6 SLISE layers sitting on top of each other. A user advisory (key) will inform the user which layers need to be discarded and which layers must then be overlaid to display the dataset.

### g) SLISE_Ig

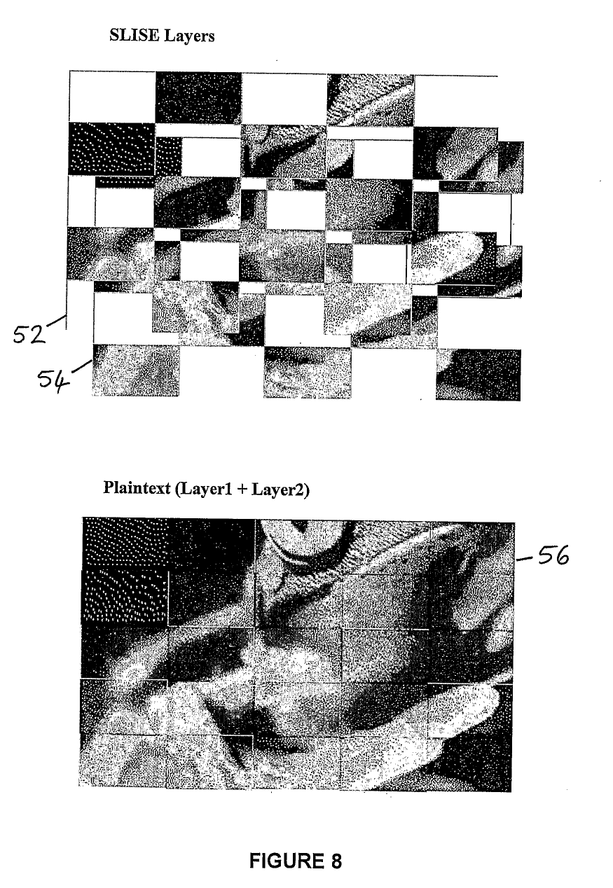

The “Ig” SLISE technique, as illustrated in FIG. 8, incorporates use of SLISE images to display patterns or pictures obfuscated within the multiple image layers 52, 54. The user is required to manipulate or otherwise overlay the layers 52, 54, and then identify the object or meaning of the resulting pattern or image 56 to provide the dataset (plaintext).

For example, in FIG. 8 the plaintext image 56 is that of a frog. This may be used in a software validation subroutine, in which the user is required to type in a passcode in order to validate the software. Thus, in the subroutine, after the user has manipulated the SLISE layers 52, 54 to reconstruct the plaintext picture 56 of the frog, he is then required to type in the name of what is shown in the image (i.e. the word “FROG”) in order to validate the software.

### h) SLISE_Ih

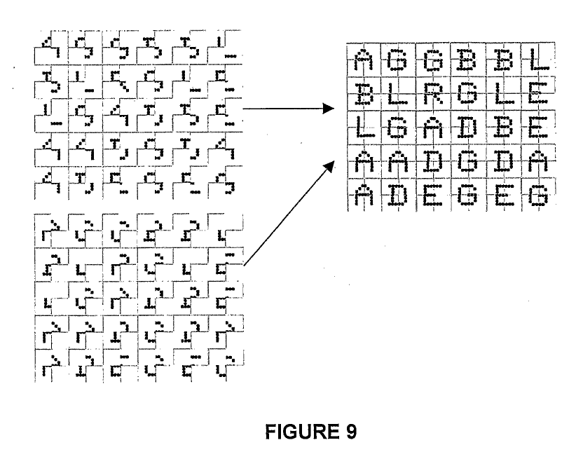

As shown in FIG. 9, the “Ih” image overlay technique incorporates multiple “crossword style” images containing obfuscated (ciphertext) characters within each grapheme/numeral field. Layer division is based on fractional division of the grapheme/numeral field (e.g. ½ or ¼ of the grapheme/numeral data is migrated into each layer). The user must overlay “crossword style” SLISE layers to display the dataset (plaintext) contained horizontally, vertically or diagonally in only a subset of total grapheme/numeral boxes.

In the example shown in FIG. 9, half of the original data in each grapheme/numeral field has been divided into separate layers. Although the grapheme/numeral fields have actually been divided into quarters they have only been allocated to 2 layers, both containing two opposite quarters of each cell. They therefore contain half the grapheme/numeral data in each cell.

Once the data layers have been overlaid the plaintext can be understood and retrieved. In the example shown in FIG. 9, the user is required to identify the correct word from a number of nonsensical words or strings that are also formed when the layers are overlaid. In this example, the word “GRADE” can be identified, running from cell C1 to C5, and this may for example be used as a password. No other five letter word is visible.

### i) SLISE_Ii

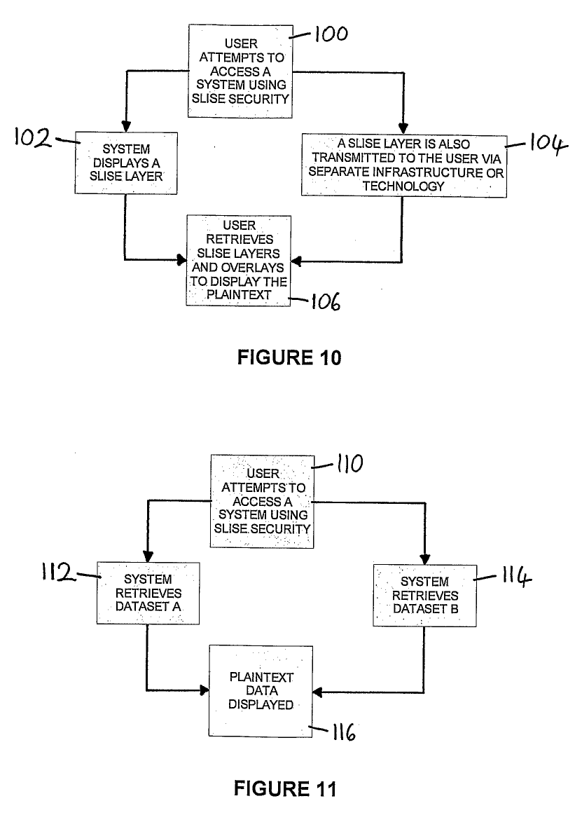

FIG. 10 shows a flow diagram illustrating the “Ii” security authorisation technique that implements SLISE image overlay technology. This technique incorporates use of transmitted SLISE image layer(s) to one or more specified user(s). The user may also receive an advisory confirming a data storage location or database location of one or more additional image SLISE layers that are to be overlaid to display the dataset (plaintext).

In the example illustrated in FIG. 10, the user is attempting to access a system for which a password is required (100). This password has been divided into SLISE layers for enhanced security. One layer is transmitted to the user and is displayed on his computer (102), whilst a second layer is transmitted to the user via a separate communications channel, network, infrastructure or technology (104). The user retrieves the SLISE layers and overlays them to display the plaintext password (106). He can then enter the password to gain access to the system.

### j) SLISE_Ij

FIG. 11 shows a flow diagram illustrating the “Ij” image overlay technique. This incorporates use of multiple data storage or database locations each containing separate SLISE image layers (ciphertext). User advisory (key) data may be supplied, allowing required image layers to be retrieved and thus displaying the dataset (plaintext).

In the example illustrated in FIG. 11, the user is attempting to access a system for which a password is required (110). This password has been divided into SLISE layers for enhanced security. The system retrieves dataset A (112) and also retrieves dataset B (114)—preferably via different communications channels. The SLISE layers are then overlaid to display the plaintext password (116). The user can then enter the password to gain access to the system.

### k) SLISE_Ik

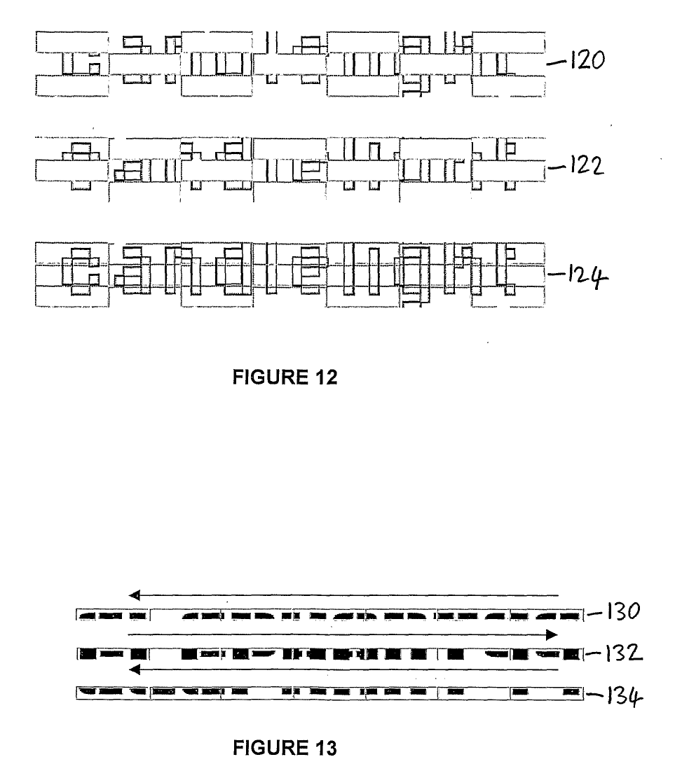

The layers need not be displayed simultaneously in order to enable the user to view the reconstructed image; rapid swapping of the image layers will also enable the user to perceive the reconstructed image. This is embodied in the “Ik” image overlay technique, as shown in FIG. 12, which incorporates use of whole or partial image swapping. In this technique, image layers 120 and 122 are not displayed at the same time, but are “hot swapped” over each other. This hot swapping may be caused to happen by user actions (e.g. moving the mouse pointer over the images) or may be automated. Although images 120 and 122 are not displayed simultaneously, the dataset (plaintext) 124 contained within the layers of data (in this case, the word “CANDLELIGHT”) can be understood by the human eye due to the speed at which the images change over or replace each other and the frame rate at which the eye receives information.

A hot swappable SLISE overlay technique could be employed in a computer's web browser, for example programmed using JavaScript or PHP. Via user action, such as placing the mouse pointer over the image or clicking a button, the image will change, swapping the visible SLISE layers. In this manner, image 120 may be repeatedly swapped with image 122. The repeated process of moving the mouse pointer over the image and removing it gives the effect that the plaintext “CANDLELIGHT” 124 is displayed. This effect is due to the speed the images switch and the frame rate at which the human eye captures the image data.

### l) SLISE_Il

The “Il” Image overlay technique, as illustrated in FIG. 13, incorporates use of moving data layers 130, 132, 134 across a screen or display (e.g. news ticker, scrolling LCD text), with the different layers moving at different speeds. The desired dataset will not be displayed until the point at which the multiple scrolling strings of data align momentarily in the correct location, thereby momentarily displaying the dataset. In this case the key is to view the data at the correct time (i.e. taking into account the 4th dimension of time).

### m) SLISE_Im

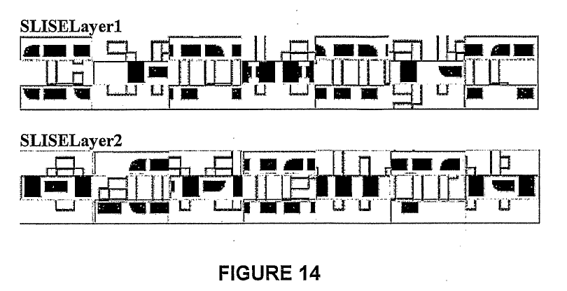

The “Im” image overlay technique, as illustrated in FIG. 14, incorporates the process of merging separate layers of data that have been extracted from unrelated datasets (but which use an identical column/row division algorithm) to increase layering security and restrict ability of data retrieval. This is due to multiple dataset SLISEs being contained in a stored image layer. Division of relevant cells or specific pixel removal would need to take place prior to the layering of the images otherwise the dataset cannot be successfully retrieved unless the user has prior knowledge of the plaintext. By decreasing the size of the data on a storage device, this technique also improves the density of data stored.

The example in FIG. 14 shows two original plaintext strings contained within the two newly created obfuscated SLISE layers. Division of the two obfuscated layers, and then the overlay process, needs to take place before it is possible for the plaintext to be retrieved or understood.

### n) SLISE_In

The “In” image overlay technique incorporates a 1/1 (whole) division level for graphemes/numerals, however the layer sizes are dissimilar to provide multiple positions in which the smaller layer(s) 152 may be overlaid over the larger layer(s) 150. This increase in the number of positions the smaller layer(s) can have over the larger layer(s) reduces the probability of the plaintext data being retrieved as the smaller layer(s) could be arranged in many different ways over the larger layer(s).

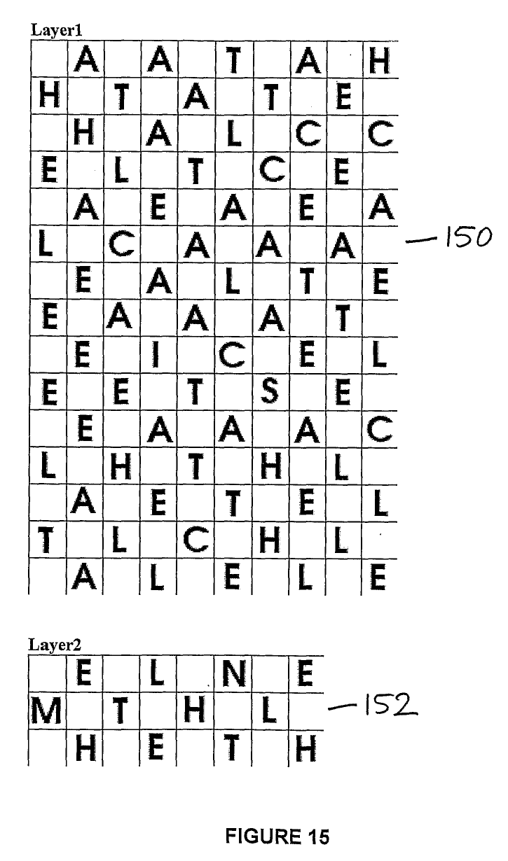

In the example shown in FIG. 15, cell A1 of Layer 2 (152) must be overlaid onto cell C8 of Layer 1 (150) to display plaintext—in this case this will display the hidden text ALAN MITCHELL TEST. Alternatively a key advising the word length of the plaintext (in this example 4,8,4) to allow user to identify the plaintext, could be provided.

### o) SLISE_Io

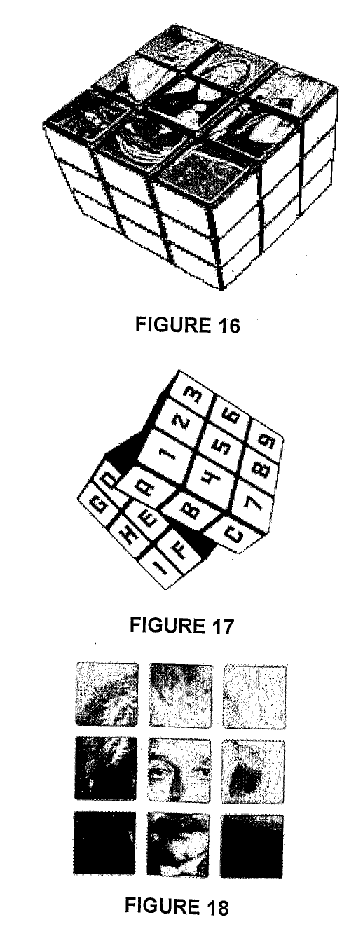

As shown in FIGS. 16 and 17, the SLISE layered obfuscation technique can be extended into a 3D modelling methodology by individually assigning datasets to each face of each layer within the 3D object that will be divided across the layers' cells. The example cube contains 27 separate cells that in the GNe version (see below) would have a grapheme or dataset assigned into each. In the Io version the data is allocated to each of the cells' faces that then make up the overall dataset in the relevant layer. In this version the example cube allows 18 datasets (across the 9 cells in the layer) to be assigned to the 18 layer faces (3 layers×6 outer faces of the cube) thus allowing up to 162 cells of data to be added to the model.

The small cubes which together form the large cube shown in FIGS. 16 and 17 may be shuffled in a similar manner to the cubes of a Rubik's Cube (although in this SLISE variant the central cube(s) are able to move to the outer layers and vice-versa), thereby distributing the datasets between the faces of the large cube. As well as moving the layers, vector based key and vector migration may be used such that the data cells may in fact face in different directions and be in different rotations from their starting positions (e.g. could appear upside down). Therefore vector migrating cell positions in a layer will affect which layer face the cells' data is viewed on and the angle in which it is then displayed. The Io version's primary application would be obfuscation of patterns or pictures due to the 4 positions in which the cell data can be displayed (0/360 degree original rotation, 90 degree rotation, 180 degree rotation and 270 degree rotation).

Vector shifts could be used to migrate the cells within the layers. When migrating cells out of a dataset all 18 datasets will be affected as the cell data is shifted into new layers, thus creating 18 new obfuscated layers that will need to be recombined to retrieve the original plaintext pattern or picture data.

For example 18 image datasets (such as the image shown in FIG. 18) would be assigned to the 18 layers of the example cube, split across the layers 9 cells.

### p) SLISE_Ip

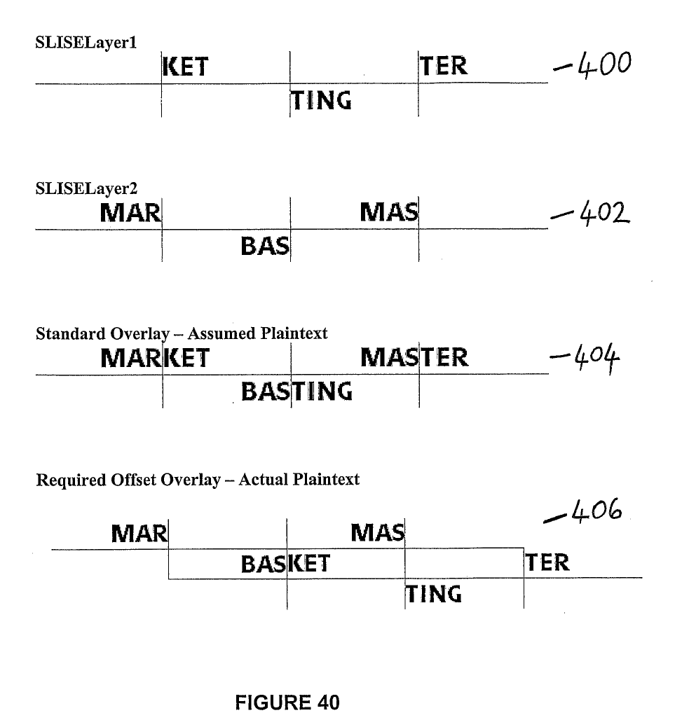

This SLISE layered obfuscation technique, as illustrated in FIG. 40, incorporates use of phonemes/graphemes of words/phrases residing in each SLISE cell that are created and distributed into separate SLISE layers 400, 402. It is then possible, via the numerous positions that the multiple layers 400, 402 could be applied to each other (e.g. Layer1 Cell B1 overlaid onto Layer2 Cell C3), to increase the number of plaintext strings that can be retrieved. Moreover, the authorisation string(s) can be further obfuscated if the separate SLISE layers are produced such that multiple known words and phrases appear if a direct one-on-one mapping overlay 404 is performed. However when overlaying the layers in an offset fashion 406, other strings are displayed that are only random text strings (in many cases, it is possible other dictionary or plain language words will appear due to them containing similar phoneme components within their structure). Alternatively these additional strings that can then be created from the layers could also be used as the plaintext string required to authorise access.

In this example illustrated in FIG. 40, the standard overlay 404 that would be performed by an uninformed individual without an advisory key would generate three possible pass phrases, “MARKET”, “BASTING” and “MASTER”, thereby offering three invalid strings that could be read and/or entered etc. However, with use of the provided advisory key and the correct layer overlay 406, the actual plaintext string that must be retrieved and entered to authorise access is “BASKET”. The advisory key can optionally advise the required cell overlay of the layers or contain a question wherein only a single word of the multiple that can be created could be the correct answer (e.g. “an object used to assist with carrying”). In further developments of this version it may also be relevant to request a concatenated or combined subset of the multiple words/phrases that must be entered to authorise access, again controlled by the advisory key.

### 4.2 Grapheme/Numeral Versions

### a) SLISE_GNa (Base Grapheme/Numeral Version)

With the “GNa” technique, obfuscation at a grapheme/numeral level (1/1 or integer) is possible. The cell grouping size may be set at any level, e.g. 1×1 grapheme upwards. Confirmation of SLISE table and data size configuration is performed (e.g. A1−N10=140 positions). Grapheme/numeral block size is then defined to create percentage allocated cells of characters that obfuscate the data (e.g. 35 blocks each containing four graphemes/numerals). Characters do not need to start from the first grapheme/numeral block (generally A1). Blocks are then divided into SLISE (ciphertext) layers, dependent on the size of the original data. A preferred block size can be determined from an optimal obfuscation table (see also: SLISE Algorithms). The text blocks may then be overlaid, based on an advisory (key), to display or decrypt the original dataset (plaintext).

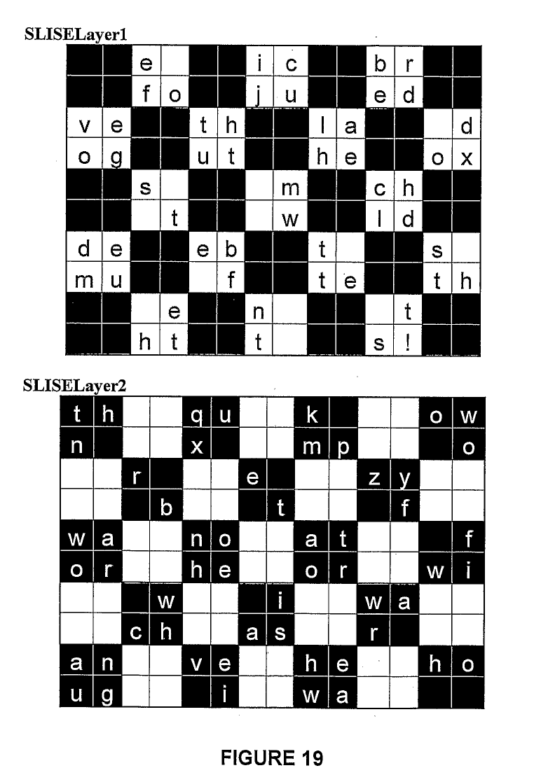

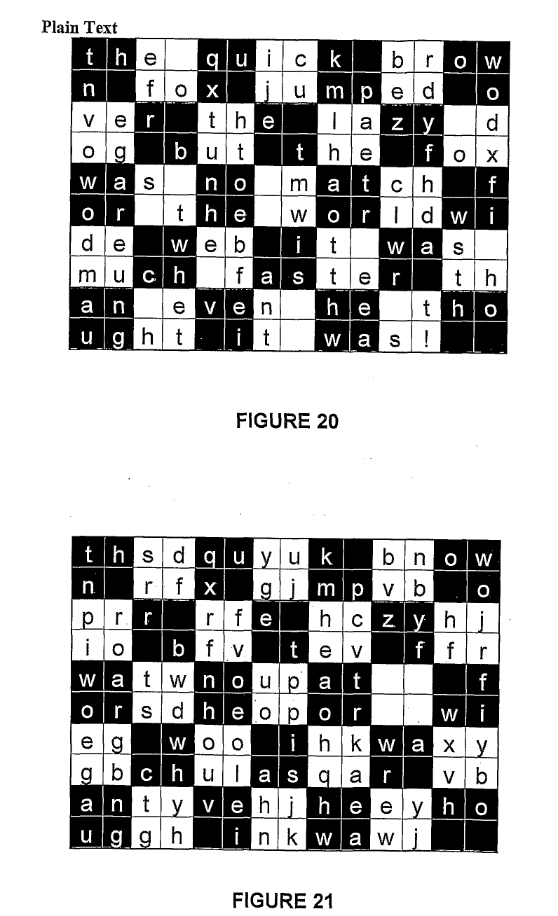

Examples of SLISE layers produced using this technique are shown in FIG. 19. FIG. 20 shows these layers having been overlaid, thereby reconstructing a message.

### b) SLISE_GNb

As illustrated in FIG. 21, the “GNb” SLISE layered text obfuscation technique incorporates use of spurious graphemes/numerals in whitespace to additionally mask original data (plaintext). Additional spurious graphemes/numerals are incorporated into the layer of data thus hiding the cell division (whitespace) that could be seen in SLISE_GNa.

### c) SLISE_GNc

The “GNc” SLISE layered text obfuscation technique incorporates a user advisory (key) informing the user of specific characters or areas within the dataset that only contain valid strings (plaintext) to be received or transmitted. All other data is spurious cell data applied to obfuscate the original data.

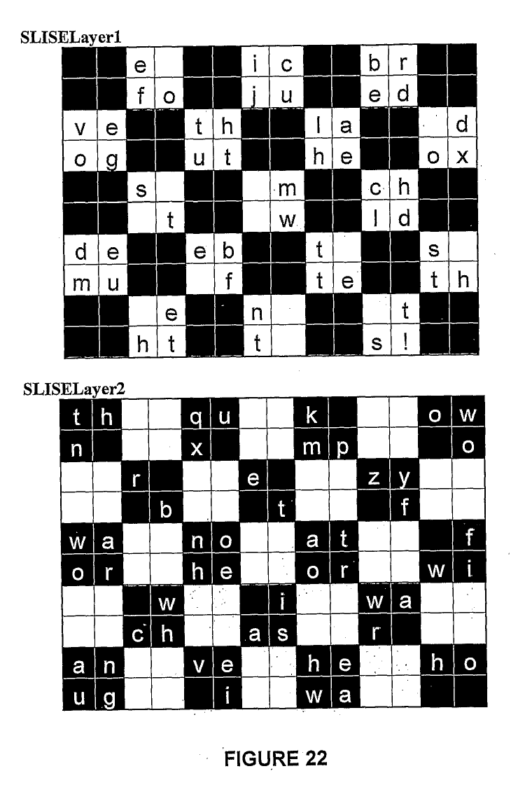

This technique is illustrated in FIG. 22. A cipher or key would be provided confirming the location within the layer, cell, or grapheme/numeral. In the example above the required string forming the plaintext phrase would be taken from SLISELayer1 (H6, K6, L6, A7, B7, E7, F7) and SLISELayer2 (16, J6, M6, N6, D7). Overlaying the cell data and retrieving these cells would display the plaintext phrase: WORLDWIDE WEB.

### d) SLISE_GNd

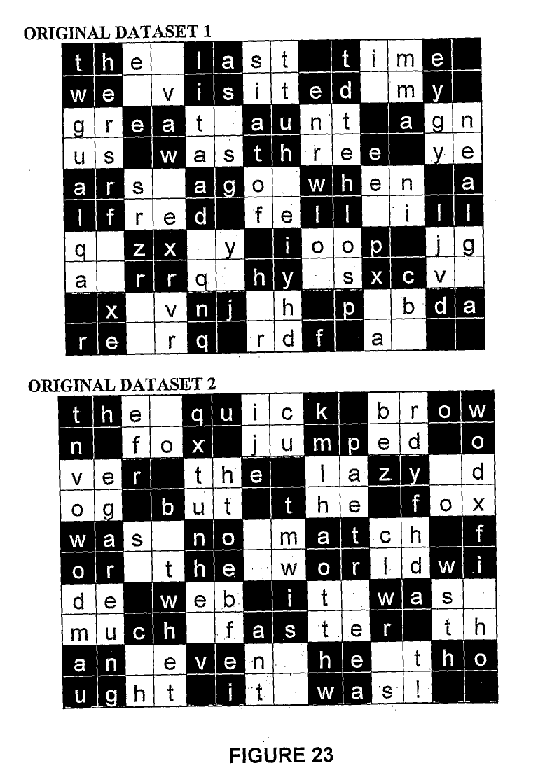

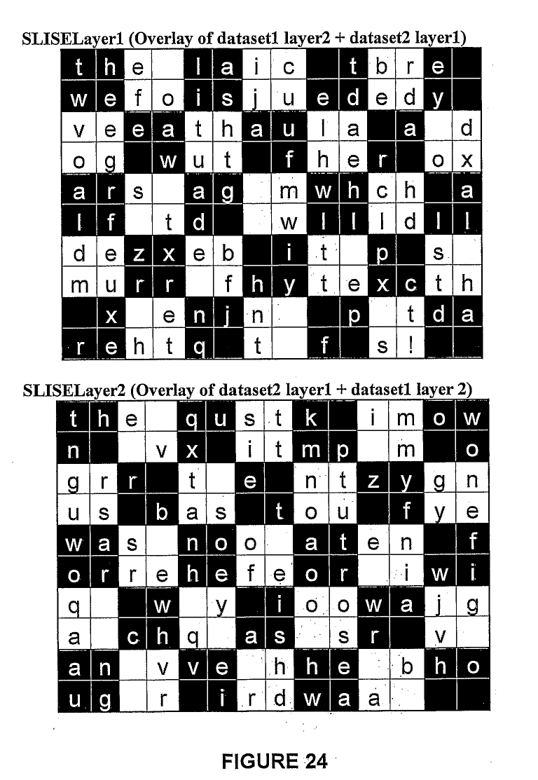

The “GNd” SLISE layered text obfuscation technique incorporates the process of independent layers being combined and stored (e.g. Dataset 1 Layer 2 and Dataset 2 Layer 1 as shown in FIG. 23) thereby creating new datasets (see FIG. 24) that ultimately display only obfuscated data. Retrieval of data will take place dependent on which data layer is required from the newly created datasets (e.g. To restore Dataset 1 of FIG. 23, relevant cells from the original Layers will need to be retrieved from obfuscated layers 1 and 2 of FIG. 24 before being overlaid and converted into plaintext).

The black and white cell definition used in the illustrations is for the purpose of example only, to show the cell size defined in these examples. In practice, the cell size would not be determinable from viewing the SLISE layers. Cell division and overlay cipher (key) allow for the cell grouping size of the original dataset cells to be retrieved and for the dataset to be overlaid and understood.

### e) SLISE_GNe

The “GNe” SLISE layered text obfuscation technique incorporates the mapping of cells and layers of SLISE data onto a 3D model to assist/enable the mixing of the layers and storing decryption key. Portions of the cell data taken from multiple data sources would then be stored on a specific layer of the 3D object. The additional encryption or obfuscation enabled by using this technique is derived from the vector based key and data migration. Vectors are used to “shift” data cells into new positions. The provision of a reverse vector map (key) enables the exact reverse “shifts” to be made, to return the data to its original plaintext (the key is an optional requirement dependent on the GNe application). In this version each grapheme or numeral is stored inside the data cells (smaller cubes) that make up the overall dataset cube; therefore each of the 27 cubes contains a single grapheme or numeral that reads the same regardless of viewpoint or vector shifts.

FIG. 25 displays the cells into which a plaintext dataset could be allocated within the cube. The data cells may then be shifted into new positions within the cube by “rotating” a set of cells based on a smaller cube size (e.g. 2×2×2) and using directional shifts (vectors). An optional key could then be provided dependent on the application of the GNe SLISE technique; the key would allow the original plaintext to be retrieved.

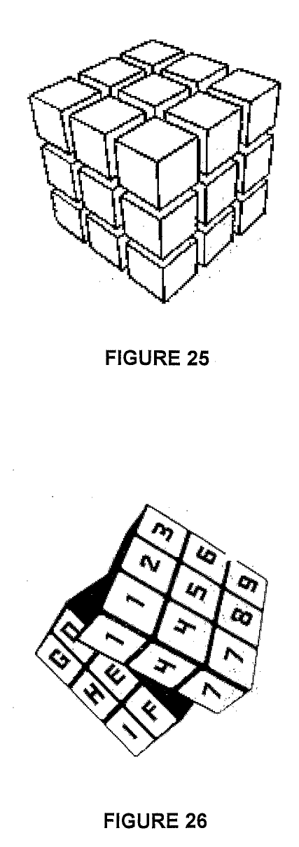

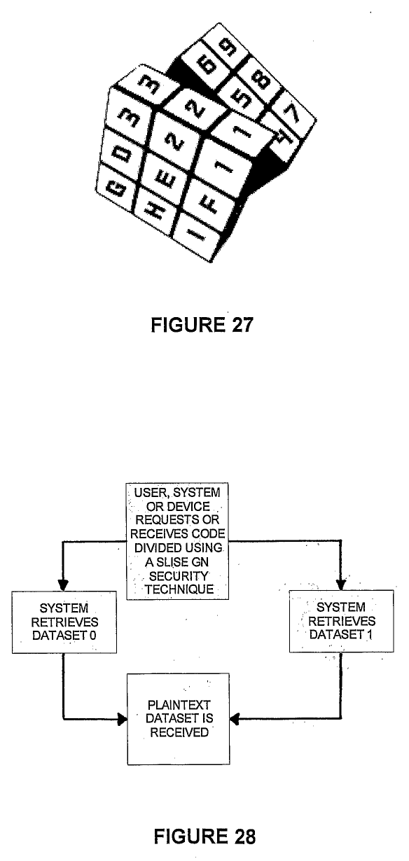

This cubes shown in FIGS. 26 and 27 contain 27 separate cells that would have a grapheme or numeral from the dataset assigned to them. By using vector shifts the data cells are moved into other layers and also other positions; without the vector key allowing these shifts to be processed in reverse the plaintext data would not be retrievable in a reasonable amount of time. The assigned graphemes in the cells of the cubes in FIGS. 26 and 27 show the movement of the data within the block when shifts are applied.

### f) SLISE_GNf

In all the “SLISE_GN” examples described above, basic English language graphemes have been used for ease of understanding. However, all the above GN version techniques are applicable to any human language, and also to any programming language or data transmission language such as binary or hexadecimal.

As described in the “SLISE—basics” section above, the grapheme/numeral technique is applicable to the atomic units of any language, advanced or basic. In respect to this, and to the additional benefits and decryption methods gained from using the GN version of SLISE on a basic computer programming language such as binary, GNf is included here to denote the specific attributes seen when applying SLISE to these languages.

Any image, sound, video or grapheme/numeral dataset may be transmitted or converted into computer code such as binary, for example in order to be transmitted digitally.

In the case of encrypting binary data, for example a binary bitstream, the bits may be split into separate streams (i.e. separate SLISE “layers”) in an alternating manner. For example, the bitstream:
. . . 1101010110111001 . . . (plaintext bitstream)
   may be split as follows (here splitting the bitstream every four bits):
SLISE bitstream layer 1: 1101 1011
SLISE bitstream layer 2: 0101 1001

In each SLISE bitstream layer, the “gaps” between the bits taken from the plaintext bitstream may be padded with 0s, 1s, or a random sequence of 0s and 1s. For example, padding the above SLISE bitstream layer 1 with 0s, and SLISE bitstream layer 2 with 1s, gives:
SLISE bitstream layer 1: 1101000010110000
SLISE bitstream layer 2: 1111010111111001

Alternatively, padding the SLISE bitstream layers with random 0s and 1s would give:
SLISE bitstream layer 1: 1101010010110011
SLISE bitstream layer 2: 0111010110111001

To decrypt the SLISE bitstream layers and obtain the plaintext bitstream, a receiver system may be configured to retrieve or receive data from each of the SLISE bitstream layers in an alternating fashion and to ignore the bits entered as padding. The receiver system may be programmed as to how many bits of each stream are padding and when it should switch between the layers in order to extract the desired bits (i.e., in this example, start with layer 1 and switch after every four bits, ignoring the groups of four bits added as padding). Alternatively, the padding bit sequences may incorporate a predefined “flag” sequence, the receiver system being programmed to switch between the layers when the “flag” sequence is detected.

Alternatively, no padding may be used in the encryption and the bits transferred into each SLISE bitstream layer may follow in a continuous sequence, i.e.:
SLISE bitstream layer 1: 11011011
SLISE bitstream layer 2: 01011001

To decrypt these layers, the receiver system may be programmed as to when it should switch between the layers in order to reconstruct the plaintext bitstream in the correct sequence (i.e., in this example, start with layer 1 and switch after every four bits).

Thus, the receiver system may retrieve or receive data from each SLISE dataset at a specific flagged, marked or received series of atomic units within each of the data layers. For example, every 4th binary bit the system may request the next 4 bits from the other dataset layer, or the system may receive a series of four 1's four 0's or another defined series of bits advising it to move to another data layer. The “swapping” point between the datasets may be stored in the encryption key, advising the system when to start retrieving or receiving data from another dataset, as well as information as to which dataset the next piece of code must be retrieved from.

Depending on factors such as processing power and memory, the system may then either buffer the dataset(s) into SLISE layers for subsequent reconstruction of the plaintext bitstream, or may reconstruct the plaintext bitstream “on the fly” in a streamed fashion.

FIG. 28 illustrates a high level flow diagram of a receiver system retrieving datasets encrypted using the SLISE_GN security technique, and thereby receiving the plaintext dataset.

### 4.3 Radio Frequency, Video and Sound Versions

### a) SLISE_RFVSa (Radio Frequency, Video or Sound Version—Frequency Division)

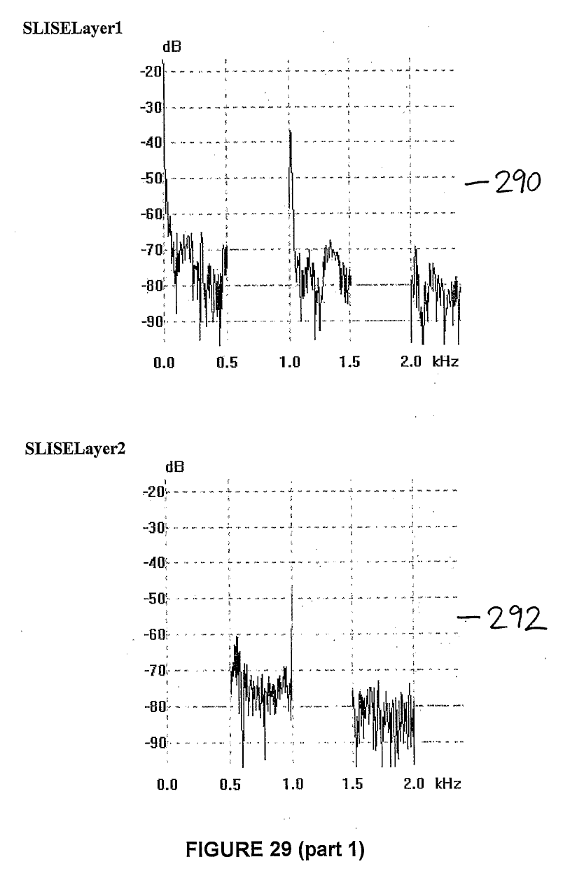

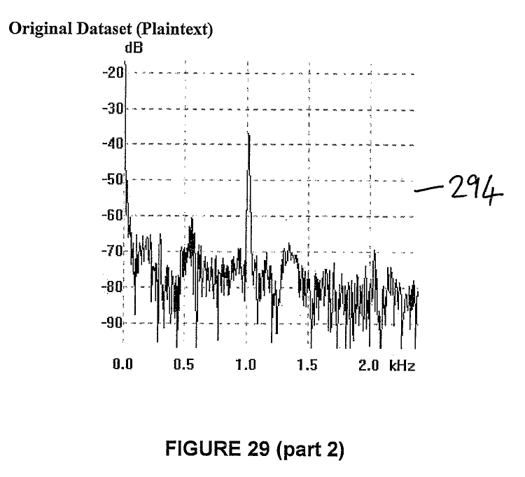

The “RFVSa” radio frequency, video or sound SLISE division and obfuscation technique, illustrated in FIG. 29, is based on frequency division. Different frequency signals are distributed into different datasets or “layers”. For example, as shown in FIG. 29, frequencies between 0.0 and 0.5 kHz, and between 1.0 and 1.5 kHz, and between 2.0 and 2.5 kHz, may be distributed into a first layer 290, whilst frequencies between 0.5 and 1.0 kHz, and between 1.5 and 2.0 kHz, may be distributed into a second layer 292. Subsequent reconstruction of the different frequency layers (294) played simultaneously enables the user to receive/understand the obfuscated data.

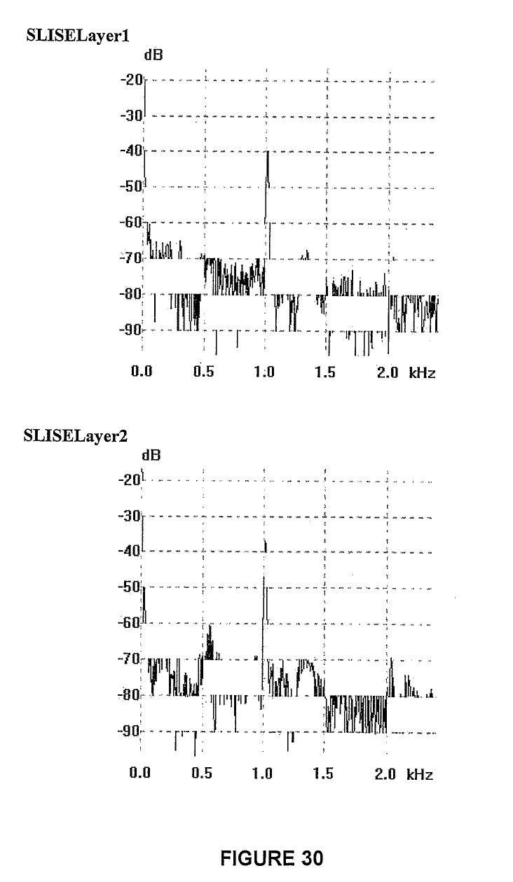

The “RFVSa” technique may thus be implemented using frequency domain based cell division (e.g. amplitude as seen on an audio spectrum analyzer). The SLISE layers of sound, video or other RF data, which may be retrieved simultaneously from diverse datasets, enable a user to receive, understand or play the data from radio waves or other RF emitting devices. Each cell may be a defined size based on overall size and obfuscation level required of original dataset. As illustrated in FIG. 30, the individual cells may only contain a specific frequency and/or amplitude range (e.g. −50 dB to −60 dB). Not all frequencies need contain data in each cell division, and the blank cells may possibly be dropped, allowing the dataset layers to be compressed (e.g. removal of 0.5 kHz to 1 kHz in the example shown in FIG. 29 would mean the cells either side could be stored in unison). A device or application processing the data would define missing blocks, uncompress, overlay and play the data layers thus “padding” the dataset back to its original size and shape.

### b) SLISE_RFVSb (Radio Frequency, Video or Sound Version—Time Division)

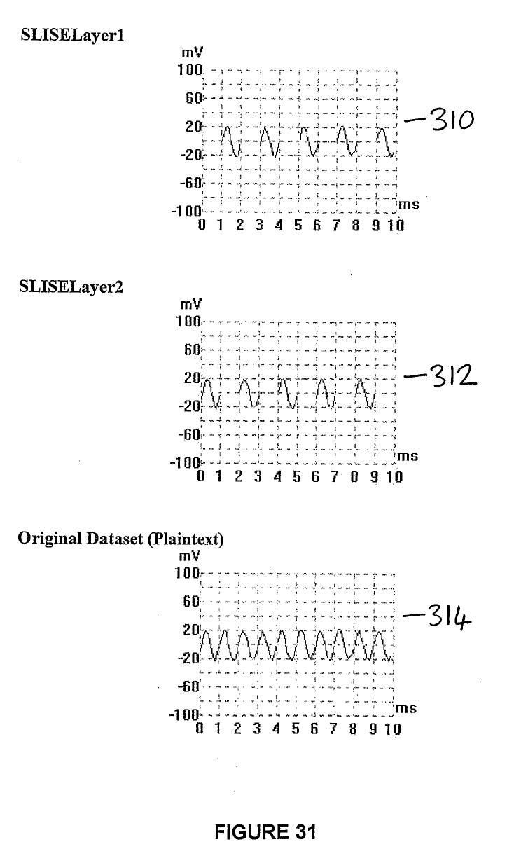

The “RFVSb” SLISE radio frequency, video or sound division and obfuscation technique, illustrated in FIG. 31, is based on the plaintext data being divided into subsets according to time instead of frequency.

As illustrated in FIG. 31, the RFVSb SLISE division and obfuscation technique may be implemented using time domain based cell division (e.g. as shown in FIG. 31 in oscilloscope view). Here, a 1 kHz wave 314 has been divided in an alternating manner every 1 ms into separate SLISE layers 310 and 312. Playing the two SLISE layers of data simultaneously enables the user to receive, understand or play the sound, video or other RF data contained within the layers. A receiver device may be required to “tune in” to multiple wavelengths simultaneously to receive the individual data layers.

The “RFVSa” and “RFVSb” techniques, when applied to the division of an audio dataset (e.g. a music data file), advantageously mean that the user is required to recombine the audio datasets (or audio “layers”) in order to play the initial audio dataset.

Playback may be achieved by first combining the audio layers to reconstruct the initial audio data and then playing the audio, or by simultaneously playing the separate audio layers. Video and other multimedia recordings can also be divided using the SLISE cryptosystem and subsequently recombined or played simultaneously to enable the original data to be restored.

This has practical applications in the transmittal and playback of audio files such as pop music downloaded from the internet or otherwise distributed electronically. For example, playback software may be configured to only permit the audio layers to be recombined a certain number of times for playback (e.g. if the music was downloaded on a trial basis, with the user being required to pay if he wishes to listen to the music on further occasions).

The user may be required to play the further audio datasets simultaneously (e.g. using dedicated software) in order to recreate the original sound. Since the audio layers would only be played simultaneously, and not combined to form the initial audio dataset prior to audio playback, this advantageously means that unauthorised copies of the initial audio dataset can be prevented from being made.

One possible distribution technique for audio that has been divided into layers will now be described. In this technique, one layer is supplied in a format such that it can be saved onto the user's computer or audio playback device. Another layer is supplied only as a data stream over a network (e.g. the Internet) and is configured such that it cannot be saved. For playback of the audio, the user employs dedicated software to play the saved layer and the streamed layer simultaneously. This adds considerable security to the distribution of audio data, for example pop music for trial purposes.

### c) SLISE_Va (Video Frame Division)

With the “Va” technique, the SLISE obfuscation technique is implemented using cell based division of the individual images that make up a single video frame, and/or additional division of the multiple frames that make up a video sequence. There are some fundamental attributes that allow TV and video to be understood by a human being that can be obfuscated using SLISE techniques.

If a still image is divided into a collection of small coloured dots, a viewer's brain will reassemble the dots into a meaningful image. By using SLISE cell division on video frames, if the “screen” or “monitor” that is to display each individual image only receives a layer of the image (e.g. a single stream of the SLISE transmission), only a cross-section of the pixels will be received and “painted” onto the display, giving an effect as seen in the SLISE_Ig (frog) image implementation above.

If a moving scene is divided into a sequence of still pictures and the still images are shown in rapid succession, the brain will reassemble the still images into a single, moving scene. By using SLISE cell division to assign alternating frames (this does not have to be individual frames, also possible to implement using groups of frames) to independent layers, if the “screen” or “monitor” that is to display each individual image only receives a layer of the video dataset (e.g. a single stream of the SLISE transmission), then only a fraction of the overall number of frames making up the entire transmission will be displayed thus obfuscating the original video signal by making it appear jerky and missing integral parts to the overall video sequence.

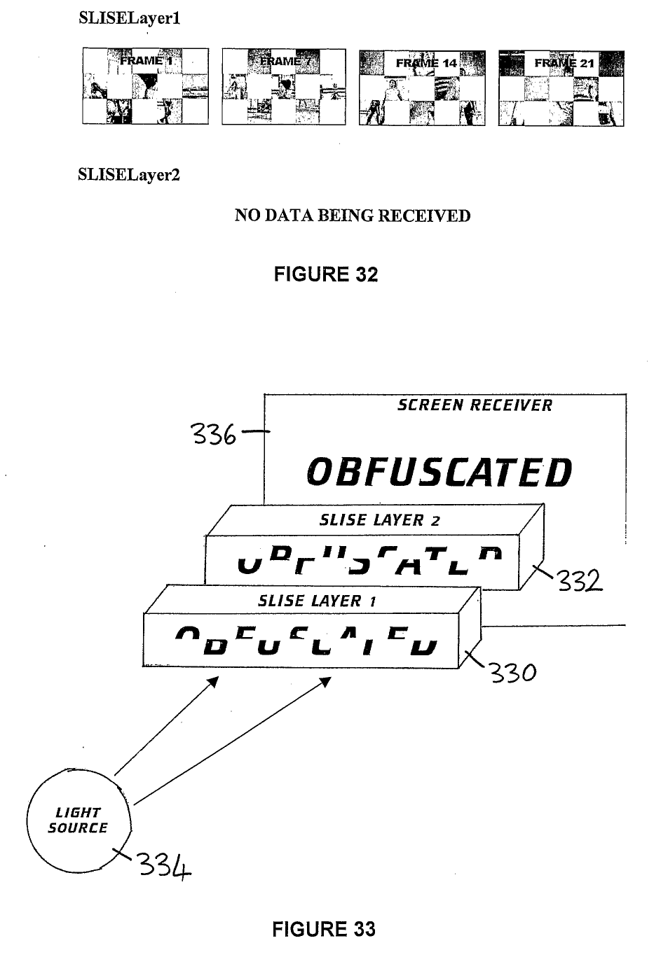

The example shown in FIG. 32 shows a music video having been divided and transmitted in SLISE layers or streams. Since only one stream is being received (no data is being received from SLISELayer2), each frame is missing vital pixels. In this case the data layers have also been divided at a frame level and the user is therefore only being displayed some of the full number of frames contained in the video. (I.e., in the example shown in FIG. 32, only frames 1, 7, 14 and 21 are being shown.) This thereby provides a way of obfuscating the original dataset, ensuring it is not transmitted in its original form, and protecting the video content from unauthorised users.

### 4.4 Physical Applications

### a) SLISE_Pa

The “Pa” SLISE physical application technique incorporates the use of SLISE division and layering methodology to display datasets containing graphemes or numerals at specified time intervals and/or spatial positions, by using manual or mechanically controlled physical layers. The physical layers may be used to control electromagnetic radiation at wavelengths visible to the human eye (i.e. light). Examples would be office toys or a large scale sculpture for use in marketing, branding or advertising. Personal information, company names or logos may be displayed on any given surface. SLISE physical obfuscation and reconstruction of layers is inherently controlled and configured by perspective or visual perception (i.e. the way in which objects appear to the eye based on their spatial attributes, or their dimensions and the position of the eye relative to the objects).

An example of a physical application is shown in FIG. 33. This figure shows two transparent objects 330, 332 (marked SLISE Layer 1 and SLISE Layer 2) that are marked or etched in specific areas, thereby containing a layer of the original dataset (in this case, the word “OBFUSCATED”. A light source 334 is arranged to beam light through the objects 330, 332. Based on their markings and position, and via a manual, kinetic or mechanical procedure, a user may change the position of the objects 330, 332 to affect the pattern of light emitted onto the screen receiver 336 (this could be a wall, floor, ceiling or other surface), and ultimately display the obfuscated dataset pattern. For this to occur successfully, the position of the objects and their respective distances from the screen receiver and from each other must be correctly configured to account for perspective.

### b) SLISE_Pb

The “Pb” SLISE physical application technique incorporates the use of SLISE division and layering methodology to display dataset patterns for use in access via the use of controlled physical layers achieving a “combination lock” type of access device.

The layers may be used to control electromagnetic radiation at wavelengths visible to the human eye (i.e. light). Due to the physical aspect of this implementation the plaintext dataset would primarily be patterns, unless layer replacement can take place at required intervals.

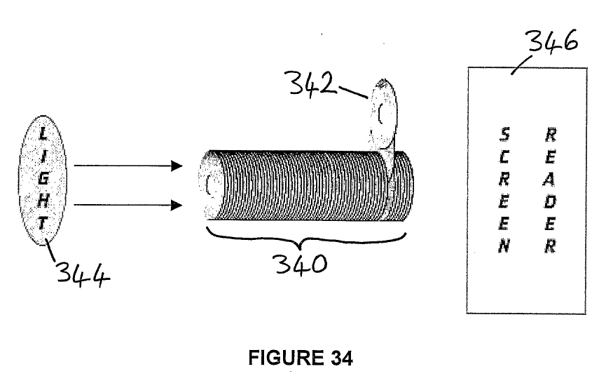

As illustrated in FIG. 34, the physical layers 340 may be arranged between one or more light emitting devices 344 and a scanning device 346, with the light emitting device(s) 344 arranged to beam light towards the scanning device 346. The layers 340 may comprise transparent, semi-transparent and/or opaque regions, and the layers may be mechanically or manually rotatable in order to encrypt, obfuscate or reconstruct a pattern or image formed by the layers. The physical layers may be rotated by a user until they are in a precise position in which only certain amounts and specific patterns of light reach the scanning device, at which point access may then be authorised.

A controlled light source 344 may be used to beam light through the objects 340. Based on their markings and position, and via a manual, kinetic or mechanical procedure, a user would be able to change the position of the objects to affect the pattern of light emitted onto the scanning screen/receiver 346, including adding or removing layers 342 in required situations. The SLISE layer objects in this example are transparent discs with etchings or markings taken from a series of datasets. They may be controlled via an internal and\or external axis that allows the discs to be added, removed, moved or changed. This SLISE technique increases the hardness of the security dependent on the number of layers and possible positions that are included in the device. Once the discs are positioned in the correct manner to obfuscate the light into the correct pattern the screen reader or scanning device will check this pattern against the pattern stored and access will be granted or denied.

### c) SLISE_Pc

The “Pc” SLISE physical application technique incorporates use of SLISE layered datasets printed on paper or other physical material that is used for communication or transmission of data from one entity to another (e.g. from human to human, or from a business to a customer). This physical implementation is an extension of the SLISE_I and SLISE_GN dataset obfuscation, cell division and layering techniques.

In the SLISE “Pc” technique, the dataset is printed onto, and distributed among, multiple layers/levels of the material (primarily paper, or other printable media), allowing for quick, safe and secure division to maintain protection of the data whilst in a physical form. This allows the original dataset to be quickly and effectively obfuscated or destroyed by the recipient by removing or “ripping off” the top layer or multiple layers of data. This ensures that the printed data is inherently secure at the point of creation (printing) and can readily be obfuscated (e.g. prior to disposal) without the specific need for taking steps such as using a paper shredder.

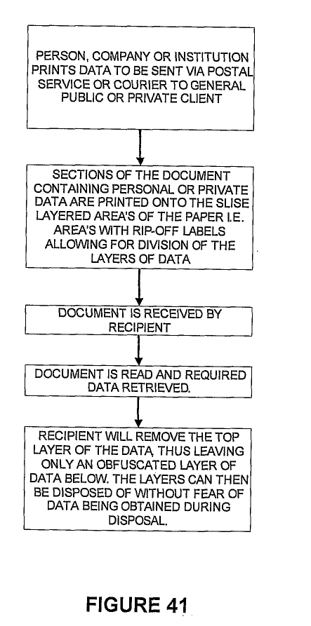

FIG. 41 is a procedural flow diagram to illustrate the SLISE “Pc” technique.

The printing of layers may be implemented in a number of ways. For example, the printing may be performed onto multiple layers of “cellular” paper, with the printed characters distributed among the multiple layers. Holes or apertures in the layers allow cells of data printed on the underneath layers to be viewed. The multiple layers may be attached on top of one another, e.g. by virtue of having adhesive backing. The multiple layers of cellular paper can then be removed or separated from one another in order to obfuscate the printed data.

An alternative technique is particularly suitable for the obfuscation of printed name and address data, for example on posted documents. One layer, comprising part of the data to be obfuscated, is printed onto a document (e.g. paper). Another layer, comprising the remainder of the data to be obfuscated, is printed onto a transparent window incorporated in an envelope. The relative positions of the print on the document and on the envelope window are such that, when the document is inserted in the envelope, the name and address dataset becomes complete and is legible. However, when the document reaches its recipient and is removed from the envelope, the printed name and address data becomes fragmented (due to part of the data being on the outside of the envelope window, not on the document) and thus the recipient's name and address data is immediately obfuscated.

Alternatively, in respect to environmental and resource limitations, one or more adhesive-backed labels (or label-like pieces) may be attached over a document or region to be printed, the labels being spatially separated from one another. The printing may then be printed over the labels in a single printing process. When it is desired to obfuscate the printed data, for example in order to protect against identity theft, the labels can be removed (e.g. peeled off) to divide up the layers easily. The inherent weakness of the labels may ensure that the removed layer (i.e. the label(s)) easily decays into a form such that returning it to its original state (without further damaging it) and then re-applying it effectively, in the correct position, to the correct layer of paper from which it was removed, would be extremely difficult and highly improbable in practice. Moreover, trying to reconstruct the original dataset in this manner would cost an identity thief (or other entity trying to obtain the data) a large amount of time and resources.

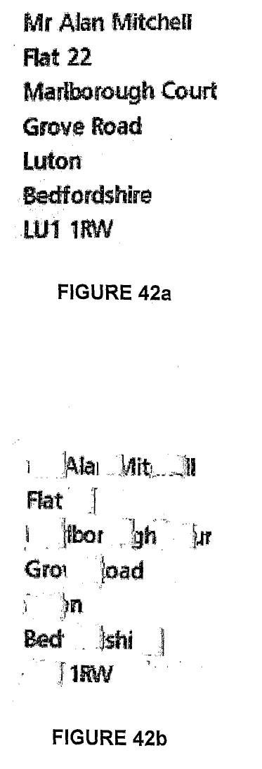

This obfuscation technique using labels is illustrated in FIGS. 42a and 42b. In FIG. 42a the name and address data has been printed onto a piece of paper on which a plurality of small removable labels were first attached, the labels being spatially separated from one another in an alternating or checkerboard-like fashion. The printed name and address data is complete and legible. In FIG. 41b, it can be seen that removal of the labels, to leave only the lower layer of paper, has resulted in the name and address data becoming obfuscated and illegible.

In the example illustrated in FIGS. 42a and 42b, the cell division only displays obfuscation of the data at approximately every 3 graphemes/numerals per cell, per layer. Manufacturing processes of labels and document templates for printing will allow for division to be applied at any number of required graphemes/numerals per cell, per layer.

### d) SLISE_Pd

The “Pd” SLISE physical application technique incorporates use of SLISE layers printed onto layers of transparent material such as acetate or tracing paper. Once facing the correct way, rotated correctly and aligned correctly, these layers would allow the person to obtain and retrieve the data contained within.

Cells making up each SLISE layer can be been printed onto separate physical layers of transparent material (e.g. tracing paper), to create a puzzle game for adults or children. The level of difficulty may be increased by the number of layers contained within the puzzle, which may be provided as a book or possibly as a series of magazines. Moreover, the level of difficulty may be influenced by the size of the layers, the number of possible positions, knowing which way the pages must face, the content of any advisory keys provided to assist, or specific attributes such as colour. Such a puzzle could be incorporated as a part or stage of a larger code book or puzzle in a game or mystery. The data to be retrieved can be a mixture of images and text making up instructions or maps to be followed, recorded or communicated.

For example a gamer, playing a murder mystery or “whodunit”, may be advised via a key or cryptic message to obtain and overlay the SLISE layers to display the name of a suspect or clue, resulting in the plaintext to be retrieved by them and enabling the game to continue. To ensure protected retrieval in full view of competitors the viewing point and spatial positioning of the layers may only allow the gamer to view the plaintext due to the perspective they have when holding up the layers at specific distances from each other.

### 5. S.L.I.S.E—Algorithms

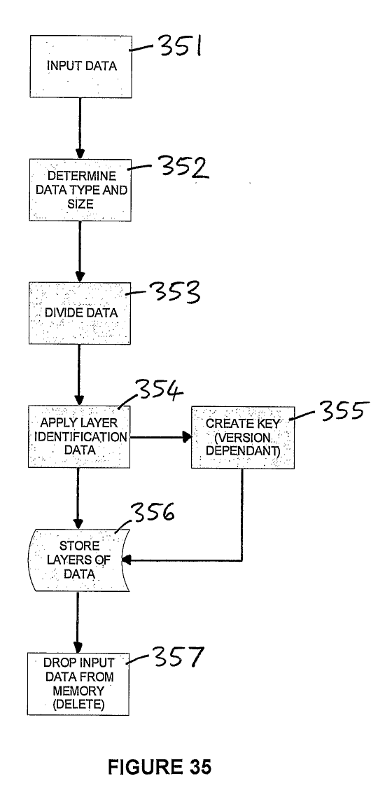

FIG. 35 illustrates a high level algorithm of a SLISE data encryption process, which may be performed by a computer processor. A first dataset to be encrypted is inputted (351). The processor then determines the data type and size of this dataset (352), and may also determine the optimum number and arrangement of cells into which the dataset will be divided. The dataset is then divided into cells, and the constituent data elements are distributed into layers (353). Layer identification data may be applied to the layers (354) and a key or advisory may be created, depending on the SLISE version being used (355). The resulting layers of data are then stored (356) and the input dataset is deleted from memory (357). This results in two or more layers which carry the initial dataset in encrypted form.

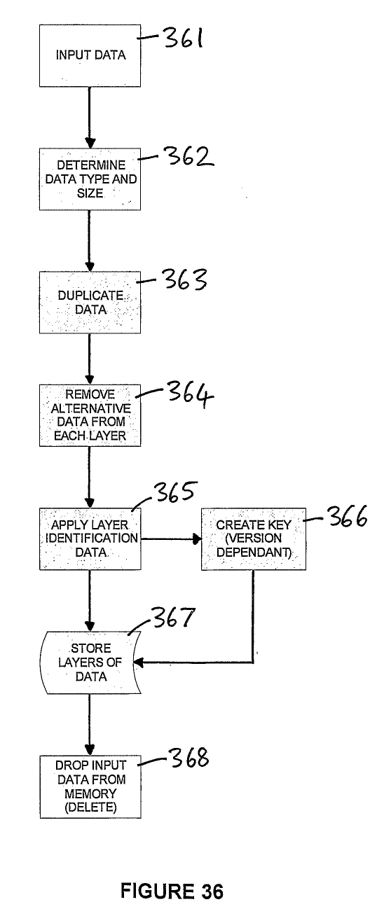

FIG. 36 illustrates a high level algorithm of another SLISE data encryption process, which may also be performed by a computer processor. A first dataset to be encrypted is inputted (361). The processor then determines the data type and size of this dataset (362), and may also determine the optimum number and arrangement of cells into which the dataset will be divided. The dataset is then duplicated to form a plurality of layers (363). Data elements are then removed from certain (e.g. alternating) cells in the duplicated layers (364). Layer identification data may be applied to the layers (365) and a key or advisory may be created, depending on the SLISE version being used (366). The resulting layers of data are then stored (367) and the input dataset is deleted from memory (368). This results in two or more layers which carry the initial dataset in encrypted form.

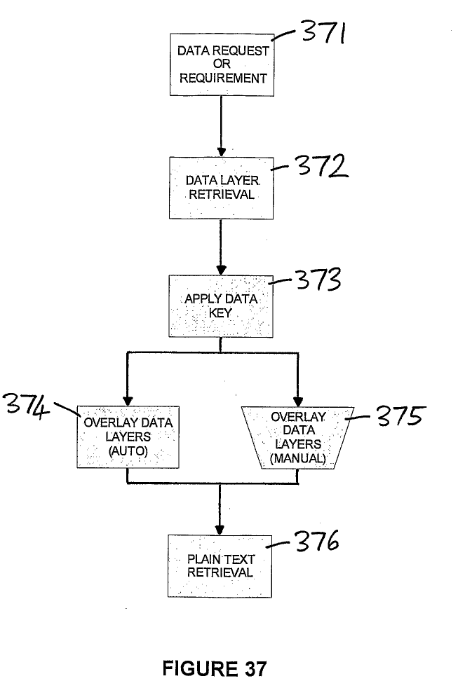

FIG. 37 illustrates a high level algorithm of a SLISE data decryption process. The user may first be presented with a request for data—for example, to enter a password (371). The system then retrieves the SLISE data layers (372) and applies the data key if applicable (373). The data layers may then be automatically merged (374) or alternatively the user may be required to manually overlay and manipulate the layers (375). The combination of the layers, correctly manipulated, will result in the decryption and retrieval of the previously-encrypted dataset (376). If the decrypted dataset is a password, the user can then enter it into the system, for example to gain access to a secure database.

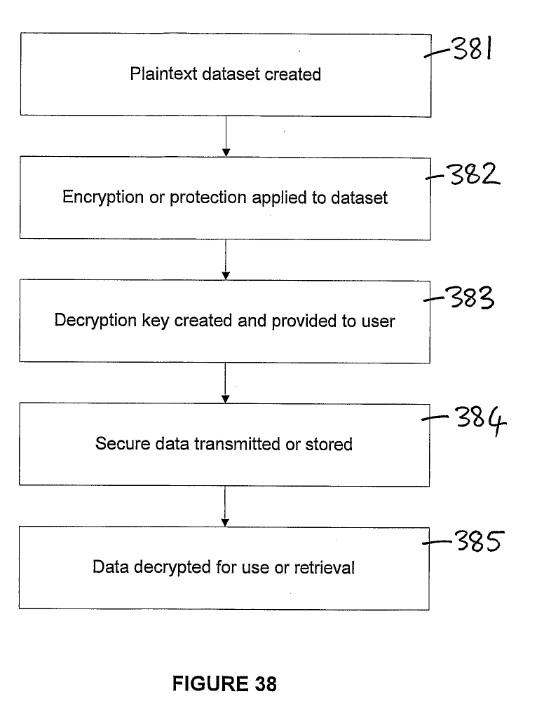

FIG. 38 shows a procedural flow diagram of a typical prior art algorithm for data encryption and decryption techniques. In this prior art algorithm, a plaintext dataset is first created or obtained (381), and encryption or other protection is then applied to the dataset (382). A decryption key may be created and provided to the user (383). The resulting secure data is then transmitted or stored (384), before finally being decrypted for use or retrieval purposes (385).

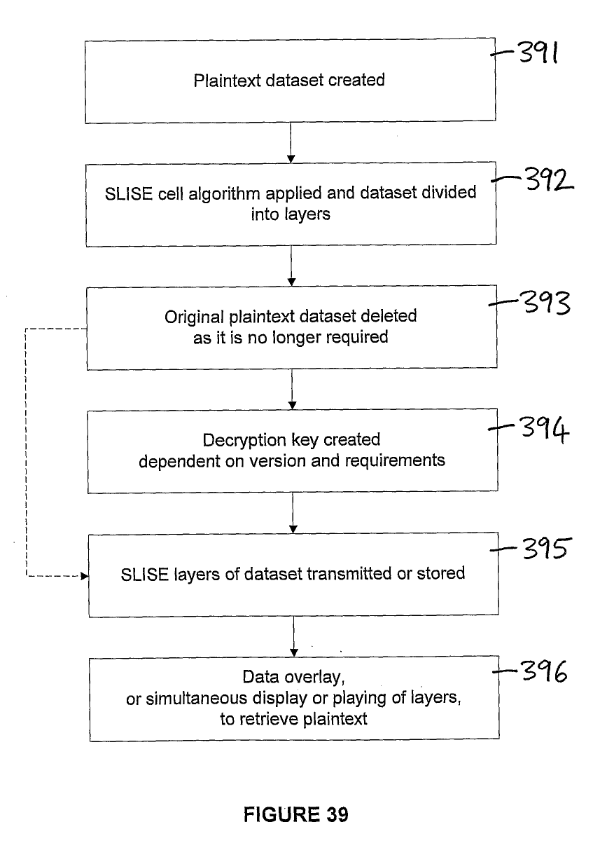

This may be compared and contrasted with the overview flow diagram of SLISE techniques shown in FIG. 39. Here, a plaintext dataset is first created or obtained (391), and then a SLISE algorithm is applied and the dataset is divided into layers (392). The original plaintext dataset may then be deleted, as it is no longer required (393). A decryption key may then be created, depending on the SLISE version and its requirements (394). The SLISE layers of the dataset may then be transmitted or stored (395). The creation of a decryption key is not always necessary, as indicated by the dashed line running directly from the deletion of the original plaintext dataset (393) to the transmission or storage of the SLISE layers (395). Finally, to retrieve the plaintext, the SLISE layers may be overlaid or simultaneously displayed or played (396).

### 6. S.L.I.S.E—Applications

Systems Access—SLISE's primary implementation would be for secure systems access, restricting non-human attempts to gain access, and increasing the difficulty of retrieving protected data by unauthorised users, system operators or hackers.
Data Storage—Hard Disk Drives could implement the SLISE cryptosystem into a new form of RAID array, wherein the data is layered for security and stored on multiple disks. In addition, all storage mediums could implement layered data division based on division and compression of data into newly obfuscated layers. This data would then need to be retrieved by a SLISE File Allocation Table (i.e. a securer version of FAT32 or NTFS).
Data Transmission—SLISE can provide secure transmissions of data, voice and other audio by dividing transmissions into layers. The SLISE cryptosystem could be implemented as a transmission header/packet transmission technology such as TCP.
Data Retrieval—SLISE restricts the ease and ability for data to be retrieved from live systems or legacy equipment that has been discarded.
Gaming—The use of SLISE image layers to complete complex puzzles can be incorporated into games. This could be implemented in any game format from puzzles (e.g. online SLISE puzzle paths and competitions) to role-playing games (e.g. Lara Croft using SLISE puzzles in an Egyptian tomb).
Access to Physical locations—SLISE layered data applied to physical layers provides the basis for an access measure device that requires positioning and layer overlay control to complete the required dataset, ultimately allowing for access to secure areas.
Printed Materials—Printing dataset layers onto separate physical layers of an object may assist with the continued protection of the data and secure disposal. For example, an “eyes only” document, that is only to be read by certain people and then destroyed, can be immediately and effectively divided—prior to going through further stages of destruction, if deemed required. Additionally, name and address information, or other data that may potentially be acquired by an “identity thief”, may readily be obfuscated and rendered illegible.

### 7. S.L.I.S.E—Further Developments

In many instances, the SLISE cryptosystem would not be intended to replace current encryption methods and technologies, but would be used as a supplementary protocol. SLISE can be advanced and improved by being implemented with other encryption techniques such as steganography and 128-bit AES (Advanced Encryption Standard). Thus, superencipherment (the practice of encrypting a message using two or more ciphering schemes in sequence) can be performed, using SLISE as one or more of the ciphering schemes. Using SLISE, it is possible to use different implementations of SLISE itself on a dataset to achieve superencipherment. By including and developing SLISE alongside other technologies it provides an additional layer of security, thus hardening security of data and transmissions.

Stereoscopy or stereoscopic imaging is an imaging technique that could be integrated to SLISE. This technique uses the concept of alternate-frame sequencing that could be applied to display layers alternatively.

### 8. S.L.I.S.E—Artificial Intelligence

Complexity theory is part of the theory of computation dealing with the resources required during computation to solve a given problem. The most common resources are time (how many steps does it take to solve a problem) and space (how much memory does it take to solve a problem). Other resources can also be considered, such as how many parallel processors are needed to solve a problem in parallel. For example, employing Image Arithmetic using the ADD, AND, OR, AVERAGE, DIFFERENCE or DARKEST functions it is possible for a computational device to recombine multiple image layers from SLISE_Ia. This ability could be beneficial to SLISE, depending on the requirement of the implementation and which version is used. Complexity theory differs from computability theory, which deals with whether a problem can be solved at all, regardless of the resources required.

Computability theory is that part of the theory of computation dealing with which problems are solvable by algorithms (equivalently, by Turing machines), with various restrictions and extensions. Computability theory addresses four main questions:
What problems can Turing machines solve?
What other systems are equivalent to Turing machines?
What problems require more powerful machines?
What problems can be solved by less powerful machines?

Not all problems can be solved. An undecidable problem is one that cannot be solved by any algorithm, even given unbounded time and memory. Many undecidable problems are known.

### 9. S.L.I.S.E—Cryptanalysis

Cryptography (from Greek kryptós, “hidden”, and gráphein, “to write”) is, traditionally, the study of means of converting information from its normal, comprehensible form into an incomprehensible format, rendering it unreadable without secret knowledge—the art of encryption.

A one-way function is a function which is easy to calculate but hard to invert—it is difficult to calculate the input to the function given its output. The precise meanings of “easy” and “hard” can be specified mathematically. With rare exceptions, almost the entire field of public key cryptography rests on the existence of one-way functions. A trapdoor one-way function or trapdoor permutation is a special kind of one-way function. Such a function is hard to invert unless some secret information, called the trapdoor, is known. RSA is a well known example. Further research will confirm whether SLISE is a true one-way or trapdoor one-way function.

1-66. (canceled)

67. A method of encrypting or obfuscating a first dataset and subsequently enabling the first dataset to be decrypted or unobfuscated, the first dataset comprising a plurality of data elements, the method comprising:
dividing the first dataset into a plurality of cells;
dividing the cells among at least two discrete further datasets, such that each further dataset comprises at least two cells, the cells in each further dataset being in spaced relation to one another, the spaced relation between the cells in a further dataset corresponding to the spaced relation between the same cells in the first dataset;
displaying the further datasets on an electronic visual display such that the arrangement of the further datasets initially renders the first dataset encrypted or obfuscated; and enabling a user to manipulate at least one of the further datasets on the visual display and thereby alter their arrangement so as to decrypt or unobfuscate the first dataset.

68. A method as claimed in claim 67, therein the absolute spatial position of a specific cell in a further dataset is the same as the absolute spatial position of the said cell in the first dataset.

69. A method as claimed in claim 67, wherein the relative spatial positions of specific cells in a further dataset are the same as the relative spatial positions of the said cells in the first dataset.

70. A method as claimed in claim 67, wherein the positions of the cells in the further datasets are such that the first dataset may be decrypted or unobfuscated by displacing one of the further datasets relative to another.

71. A method as claimed in claim 67, wherein the positions of the cells in the further datasets are such that the first dataset may be decrypted or unobfuscated by enlarging or reducing one of the further datasets relative to another.

72. A method as claimed in claim 67, wherein a cell comprises a single data element.

73. A method as claimed in claim 67, wherein a cell comprises a plurality of data elements.

74. A method as claimed in claim 67, wherein a cell comprises a fraction of a data element.

75. A method as claimed in claim 67, wherein the first dataset is one of a plurality of first datasets, and the method comprises dividing cells from each of the plurality of first datasets among the discrete further datasets.

76. A method as claimed in claim 75, wherein the step of dividing the cells results in at least one of the further datasets comprising data elements from a plurality of first datasets.

77. A method as claimed in claim 67, wherein the first dataset is one of a plurality of first datasets, and the method comprises dividing cells between the first datasets to form the further datasets.

78. A method as claimed in claim 67, wherein the step of dividing the cells is performed using vector migration of the data elements.

79. A method as claimed in claim 67, further comprising adding additional data elements between the cells divided among the further datasets.

80. A method as claimed in claim 79, wherein the additional data elements are chosen at random.

81. A method as claimed in claim 79 further comprising enabling the user to remove data elements in order to decrypt or unobfuscate the first dataset.

82. A method as claimed in claim 67, further comprising providing the user with a key or instructions in order to enable him to reconstruct the first dataset.

83. A method as claimed in claim 67, further comprising transmitting the further datasets on separate data communications channels or networks.

84. A method as claimed in claim 67, wherein the first dataset comprises an image.

85. A method as claimed in claim 67, wherein the first dataset comprises alphanumeric characters and/or graphemes.

86. A method of encrypting or obfuscating a first dataset and subsequently enabling the first dataset to be decrypted or unobfuscated, the first dataset comprising a plurality of data elements, the method comprising:
dividing the data elements into at least two discrete further datasets;
displaying the further datasets on an electronic visual display such that the arrangement of the further datasets initially renders the first dataset encrypted or obfuscated; and
altering the arrangement of the further datasets over time, such that the first dataset is momentarily decrypted or unobfuscated.

87. A method as claimed in claim 86, further comprising providing the user with a key or instructions in order to enable him to reconstruct the first dataset.

88. A method as claimed in claim 86, further comprising transmitting the further datasets on separate data communications channels or networks.

89. A method as claimed in claim 86, wherein the first dataset comprises an image.

90. A method as claimed in claim 86, wherein the first dataset comprises alphanumeric characters and/or graphemes.

91. A method of encrypting or obfuscating a first dataset and subsequently enabling the first dataset to be decrypted or unobfuscated, the first dataset comprising a plurality of data elements, the method comprising:
dividing the data elements into at least two discrete further datasets, the further datasets separately being such as to encrypt or obfuscate the first dataset; and
displaying the further datasets on an electronic visual display in an alternating manner such that, when viewed by a user, the user can perceive the first dataset in decrypted or unobfuscated form.

92. A method as claimed in claim 91, wherein the alternating display of the further datasets is in response to a user action.

93. A method as claimed in claim 92, wherein the user action comprises moving a mouse pointer over a further dataset.

94. A method as claimed in claim 91, further comprising providing the user with a key or instructions in order to enable him to reconstruct the first dataset.

95. A method as claimed in claim 91, further comprising transmitting the further datasets on separate data communications channels or networks.

96. A method as claimed in claim 91, wherein the first dataset comprises an image.

97. A method as claimed in claim 91, wherein the first dataset comprises alphanumeric characters and/or graphemes.
